(19) United States
(12) Patent Application Publication
(10) Pub. No.: US 2013/0036007 A1
(43) Pub. Date: Feb. 7, 2013

(54) CROSS-PLATFORM COLLECTION OF ADVERTISING METRICS

(71) Applicant: Emil O. Lau, Sherman Oaks, CA (US)

(72) Inventors: Emil O. Lau, Sherman Oaks, CA (US); Jake K. Dodd, Los Angeles, CA (US)

(21) Appl. No.: 13/463,356

(22) Filed: May 3, 2012

Related U.S. Application Data
(60) Provisional application No. 61/483,250, filed on May 6, 2011.
(60) Provisional application No. 61/483,222, filed on May 6, 2011.
(60) Provisional application No. 61/483,206, filed on May 6, 2011.
(60) Provisional application No. 61/511,261, filed on Jul. 25, 2011.

(51) Int. Cl. G06Q 30/02

(52) U.S. Cl. 705/14.49

(57) ABSTRACT

Systems and methods for integrating supplemental advertising content between both network advertisements and television advertisements are described. A central server connected to a network accesses a database containing supplemental advertising content that is paired with a specific serial identifier, allowing users to retrieve the content by utilizing a network-connected device to send the server a request containing the serial identifier. The network-connected device also connects to a different server that accesses a database containing user profiles that keep track of which content requests the user has sent, allowing the user to access the requested content from any other network-enabled device.

### CROSS-REFERENCE TO RELATED APPLICATION

This application claims priority pursuant to 35 U.S.C. §119(e) to U.S. provisional applications Ser. No. 61/483,250 filed May 6, 2011, Ser. No. 61/483,222 filed May 6, 2011, Ser. No. 61/483,206 filed May 6, 2011, and Ser. No. 61/511,261 filed Jul. 25, 2011, which applications are hereby incorporated by reference, in their entirety.

### FIELD

The present application relates to electronic communication, and more particularly to cross-platform collection of advertising metrics using computer networks and other communication modes.

### BACKGROUND

Advertising can for the same or similar product may be published and received by prospective customers using many different media platforms; for example, traditional broadcast, satellite or cable television, analog, digital, or satellite radio broadcasting, via Internet web pages or streaming media on all types of computing platforms, and traditional print media. A single user may receive advertising from different platforms, some of which do not allow for convenient interaction with an advertiser or that do not integrate well with different client devices used by the consumer. In addition, consumers often lack a convenient way to obtain further information about a cross-platform advertising product, including but not limited to promotional information, discounts, consumer reviews, and so forth. It would be desirable, therefore, to overcome these and other limitations of the prior art with a new system and method for cross-platform collection of advertising metrics.

### SUMMARY

Methods, apparatus and systems for cross-platform collection of advertising metrics are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

The present technology may be used for downloading and storing of information that is platform agnostic. For example, while someone is surfing the Internet or watching TV, and sees an advertisement for a product of interest, the person can use their remote control, voice command and/or smart phone to store that information for later viewing. This storage of information may be presented as essentially adding a Harvest Card™, sometimes referred to herein as supplemental advertising content, to the viewer's Harvest collection in a network (e.g., cloud storage) location for storing the viewer's Harvest Cards. In an aspect, the Harvest Card may be transmitted to the viewer's client device; e.g., mobile phone, PC, notepad computer, or the like. A similar process may be used for users viewing ads while surfing the Internet.

A defined user input, e.g., click action, may be used to initiate download of a Harvest Card to the user's account. Thus, the Harvest Card user may download the Harvest Card containing information on the product they are interested in from multiple media sources, e.g. TV, smartphones, the internet, because the Harvest Card is platform agnostic. The Harvest card may include security features (e.g., security keys) to ensure that only authorized cards are provided to users that indicate interest in an advertised product or service.

The Harvest Card information may be configured so that users can comment about items listed in Harvest cards, allowing for users to give their opinions on anything with a Harvest card. For example, a Harvest card for an episode of a popular TV show may be used to facilitate viewer opinions on the show, who sang the best, etc. Another example would be reviews for a particular item, let's say a Nike shoe. Also, let's say we have two friends Bill and Sally. Let's also say Bill bought this Nike shoe and gave it a positive review. Now, the next time Sally is looking for a shoe, she can use Harvest to look at reviews of shoes by her friends (Bill) and see that Bill really likes his Nike shoe.

In another aspect, consumers may review the advertisements themselves in order to figure out which are useful and which are not. Viewer feedback on this topic may be combined with the demographic of viewer to deliver personal advertisements that the viewer would actually enjoy. This may be used to make advertisements a lot more efficient and profitable. Consumer metrics on the aforementioned and all who downloaded the Harvest Card may be transmitted back to the advertiser in a novel manner to the advertisers as well as tracking of conversions in real time.

Consumers may also publish Harvest Cards in social networking sites of the like. In this way, friends may use the Harvest Card to help each other to make purchase decisions. For instance, if a woman wanted to buy a dress, she may post it on her wall as a Harvest Card and her friends may comment for or against it. A user may send her Harvest cards to other friends as well.

To accomplish these and other aspects of the present technology, a method for cross-platform collection and distribution of advertising information may include maintaining, in a computer memory, a data structure relating unique advertisement identifiers associated with respective corresponding advertisements distributed across multiple media platforms. The method may further include receiving, by a computer server, defined electronic signals comprising ones of the unique advertising identifiers associated with respective user identifiers. The method may further include maintaining, in a computer memory, records of the ones of the advertising identifiers associated with each of the user identifiers received in the defined electronic signals. The method may further include selecting destination clients based on the user identifiers, and transmitting supplemental content selected based on the advertising identifiers to the destination clients.

In addition, the method may include assigning the unique advertisement identifiers to one or more advertisements for distribution across multiple media platforms, in response to registration requests from advertisers. In another aspect, the method may include collecting the supplemental content from one or more sources. The method may include allocating the supplemental content to respective ones of the advertising identifiers in a computer data structure. The one or more sources may include advertisers publishing the advertisements. The method may include including promotional material from the advertisers in the supplemental content.

In other aspects, the method may comprise including consumer reviews collected from other users in the supplemental information. In another aspect, the method may include receiving a request for the supplemental information from a client device, wherein the request includes one of the user identifiers. In such case, the method may include formatting the supplemental information for display for a platform type compatible with the client device, prior to the transmitting. In addition, the method may include providing an interface object in the supplemental information for input of user data on the client device and providing the input as user feedback.

In related aspects, a computer system may be provided for performing any of the methods and aspects of the methods summarized above. A system may include, for example, a computer server including a processor and a memory, wherein the memory holds instructions for execution by the processor to cause the apparatus to perform operations as described above. An article of manufacture may be provided, including a non-transitory computer-readable medium holding encoded instructions, which when executed by a processor, may cause an apparatus to perform the methods and aspects of the methods as summarized above.

Further embodiments, aspects and details of methods, apparatus and systems for cross-platform collection and distribution of advertising information are presented in the detailed description that follows.

### BRIEF DESCRIPTION OF THE DRAWINGS

The present technology, in accordance with one or more various embodiments, is described in detail with reference to the following figures. The drawings are provided for purposes of illustration only and merely depict typical or example embodiments of the technology. These drawings are provided to facilitate the reader's understanding of the technology and shall not be considered limiting of the breadth, scope, or applicability of the technology.

FIGS. 1-7 are block diagrams illustrating different aspects of systems for collecting cross-platform advertisement metrics.

FIG. 8 is a sequence diagram illustrating an example of a call flow for collecting cross-platform advertisement metrics.

FIGS. 9A-E are block diagrams illustrating different aspects of systems for integrating television and internet advertisement content.

FIG. 10 is a flow chart illustrating aspects of a process for integrating television and internet advertisement content.

FIGS. 11A-B are sequence diagram illustrating an example of a call flow for integrating television and internet advertisement content.

FIGS. 12A-C are block diagrams illustrating different aspects of systems for delivering user-requested advertisement content.

FIG. 13 is a flow chart illustrating aspects of a process for delivering user-requested advertisement content.

FIGS. 14A-B are sequence diagram illustrating an example of a call flow for delivering user-requested advertisement content.

FIG. 15 is a block diagram illustrating a system for delivering user-requested advertisement information from electronic games.

### DETAILED DESCRIPTION

Various different aspects of the present technology are described under the headings below. The headings are provided for the convenience of the reader, and should not be construed as limited the detailed description in any manner.

### Collecting Cross-Platform Advertisement Metrics

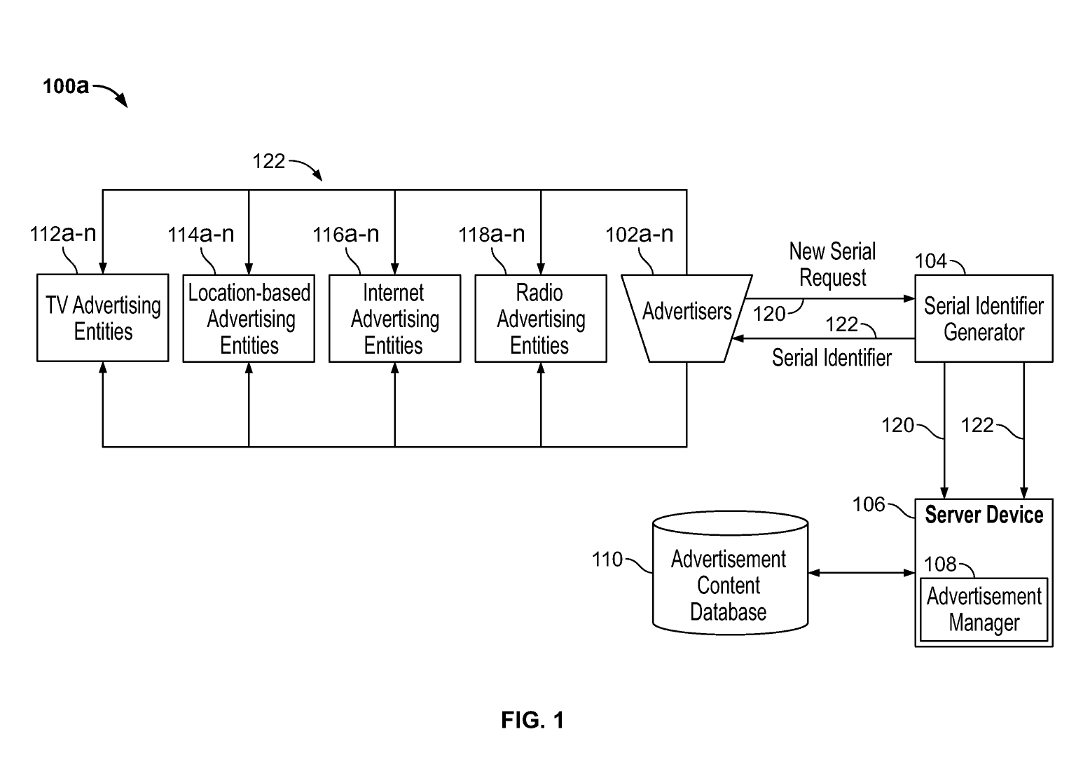

Referring now to the drawings in which like numerals indicate like elements throughout the several figures, FIG. 1 is a block diagram exemplifying an implementation of a system 100a for collecting cross-platform advertisement metrics according to aspects of the disclosure. The system 100a shown in FIG. 1 includes several advertisers 102a-n who wish to track advertising metrics through the distribution of a serial identifier 122. These advertisers 102a-n may include, but are not limited to, any person, persons, corporations or small businesses that desire to advertise goods or services in local, domestic, or international markets.

To begin tracking advertising metrics, a client device 102a operated by an advertiser (the client device sometimes referred to as an “advertiser” for short) first sends a new serial identifier request 120 to a serial identifier generator 104 which creates a serial identifier 122 specifically identifying an individual advertisement, or collections of advertisements. The serial identifier 122 may be, or may include, an identification code such as, for example, an alphanumeric serial number. A serial identifier generator 104 may be, or may include, a digital device including a processor, a Random Access Memory (RAM) bank, and a digital data storage system, such as a personal computer, operating an algorithm of generating and recording a serial number sequence. The serial identifier generator 104 may comprise hardware and/or software executed by the processor to assign an identification code in response to receiving a new serial request 120.

After creating a serial identifier 122, the serial identifier generator 104 may deliver the serial identifier 122 to a server device 106 that executes an advertisement content manager application program 108. The advertisement manager 108 may access an advertisement content database 110 that stores the serial identifier 122 and pertinent information which includes, but is not limited to, the advertiser 102a requesting the serial identifier 122. When the serial identifier generator 104 confirms that the serial identifier 122 and its associated information have been stored in the database 110, the serial generator 104 delivers the serial identifier 122 that references the advertisement or collection of advertisements to the advertiser 102a. The advertiser 102a consequently delivers their advertisement or collection of advertisements and the associated serial identifier 122 to one or more advertising entities 112-118a-n, which include, but are not limited to, television advertising entities 112a-n, location-based advertising entities 114a-n, internet advertising entities 116a-n, and radio advertising entities 118a-n.

A television advertising entity 112a-n may include any person, persons, corporations, or entities that own, sell, have direct or indirect access to, or otherwise place, advertisements that are delivered through an analog or digital signal, to be viewed on a television device. Examples of such signals include analog radio signals, digital radio signals, and digital cable signals. Examples of television devices include Cathode Ray Tube (CRT) television sets, Liquid Crystal Display (LCD) television sets, digital projectors, and personal computer monitors.

Location-based advertising entities 114a-n include, but are not limited to, any person, persons, corporations, or entities that own, sell, have direct or indirect access to, or otherwise place, advertisements that are displayed visually, audibly, or otherwise in private or public locations. Examples of such advertisements include poster advertisements, billboard advertisement, spoken advertisements, and movie theater advertisements.

The internet advertising entities 116a-n include, but are not limited to, any person, persons, corporations, or entities that own, sell, have direct or indirect access to, or otherwise place, advertisements that are accessible through the Internet. Examples of internet advertisements include webpage banner advertisements, click-based advertisements, video-embedded advertisements, pop-up advertisements, and interactive advertisements.

A radio advertising entity 118a-n includes, but is not limited to, any person, persons, corporations, or entities that own, sell, have direct or indirect access to, or otherwise place, advertisements that are delivered through an analog or digital signal, and received by a radio receiver device. Examples of such signals include analog radio signals, digital radio signals, microwave signals, and satellite radio signals. Examples of radio receiver devices include transistor radios, clockwork radios, automobile radios, portable radios, and satellite radios.

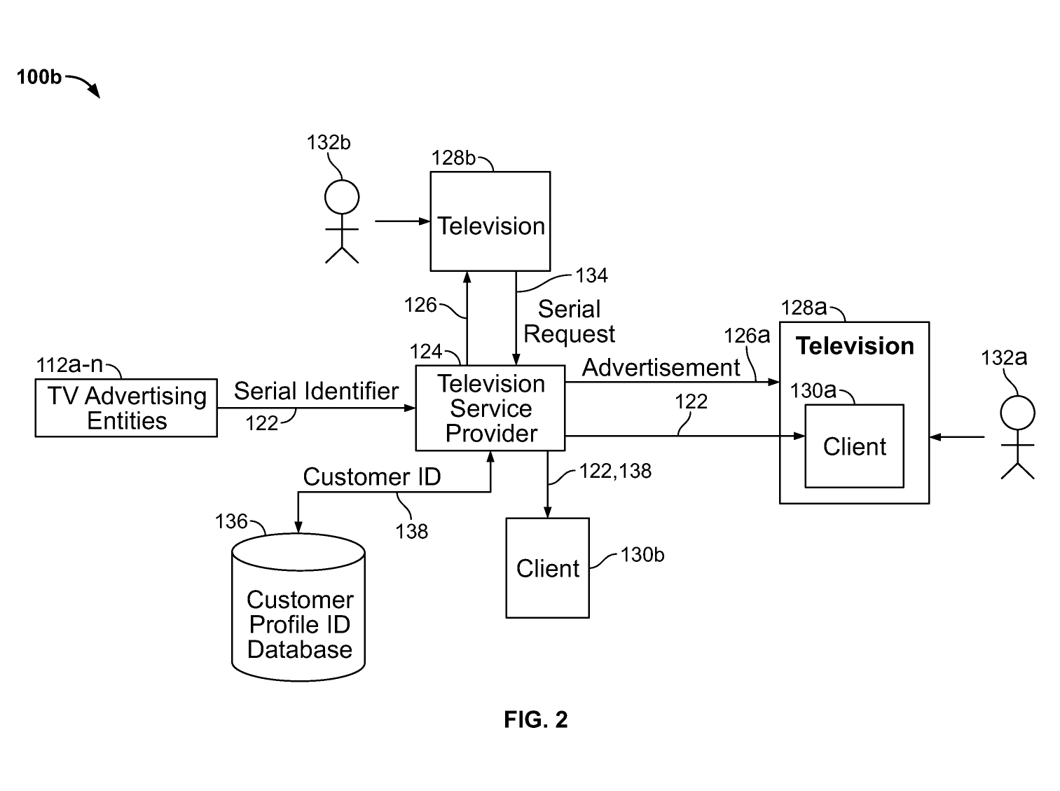

Referring now to FIG. 2, there is shown block diagram exemplifying an implementation of a system 100b that may be included as a component of the present technology. The system 100b includes several users 132a-b receiving a television advertisement 126a from a television service provider 124 via television devices 128a-b. The television service provider 124 may be, but is not limited to, any persons, corporations, or entities that deliver digital or analog television signals to customers, whether directly or through an intermediary. An example of a television service provider 124 would be a digital cable or satellite television provider, such as Verizon Communications Inc. or Comcast Corporation. The television advertisement 126a includes any and all advertising content delivered through an analog or digital signal to the user 132a-b, which may appear within television shows, pay-per-view programming, games, programming menus, or any such television environment. When one or several television advertising entities 112a-n deliver a television advertisement 126a to a television service provider 124, the serial identifier 122 associated with that advertisement is also delivered.

One user 132a of the system 100b utilizes a television device 128a interacting with a client device 130a that resides within, exists as a component of, or otherwise interfaces with the television 128a. Examples of a client device 120a include any and all processor-based devices capable of interacting with or executing application programs, and capable of connecting to and communicating with a network. Examples of a paired television and client device include a smart phone or notepad Internet TV with Google™ TV. When the television advertisement 126a is delivered to the television 128a incorporating a client device 130a, the serial identifier 122 associated with that advertisement is also delivered. The method for delivering the serial identifier 122 from the television service provider 124 to the television 128a is not limited by the embodiment of the current technology, but may include a channel within a multiplexed signal, or encoding within content delivered through the television signal. The user 132a, upon viewing the advertisement 126a, may express interest or disinterest concerning the advertisement 132a by interacting with the television 128a or client device 130a interfacing with the television 128a to extract the serial identifier 122 associated with the advertisement 126a, and store the serial identifier 122 within the client device 130a or within any storage device interfacing with the client device 130a.

Another user 132b of the system 100b utilizes a television device 128b that has no ability to interface with such a client device 130a. This user 132b, when viewing the television advertisement 126a the television 128b, may express interest or disinterest concerning the advertisement 132a by making a request 134 to the television service provider 124 for the serial identifier 122 associated with the advertisement 126a. The methods for delivering the serial request 134 to the television service provider 124 are not limited by the embodiment of the present technology, but may include the utilization of Enhanced Binary Interchange Format (EBIF), or a channel within a multiplexed digital signal. The television service provider 124, having received the user's 132b serial request 134, references a customer profile identification database 136 and retrieves a customer identification 138 associated with the user 132b. The television service provider 124 consequently delivers the customer identification 138 and the requested serial identifier 122 to a client device 138.

Such a client device 138 may include, but is not limited to, personal computers, mobile phones, cellular phones, smart phones, digital tablets, personal digital assistants, laptop computers, Internet appliances, and other processor-using digital platforms capable of interfacing directly or indirectly with a network such as the Internet, and capable of interacting with application programs. Examples of a client device 138 include, for example, a digital tablet executing a browser application program such as Apple Computer, Inc.s Safari, or a personal computer executing a browser application program such as Apple Computer, Inc.'s Safari™ or Microsoft Corporation's Internet Explorer™.

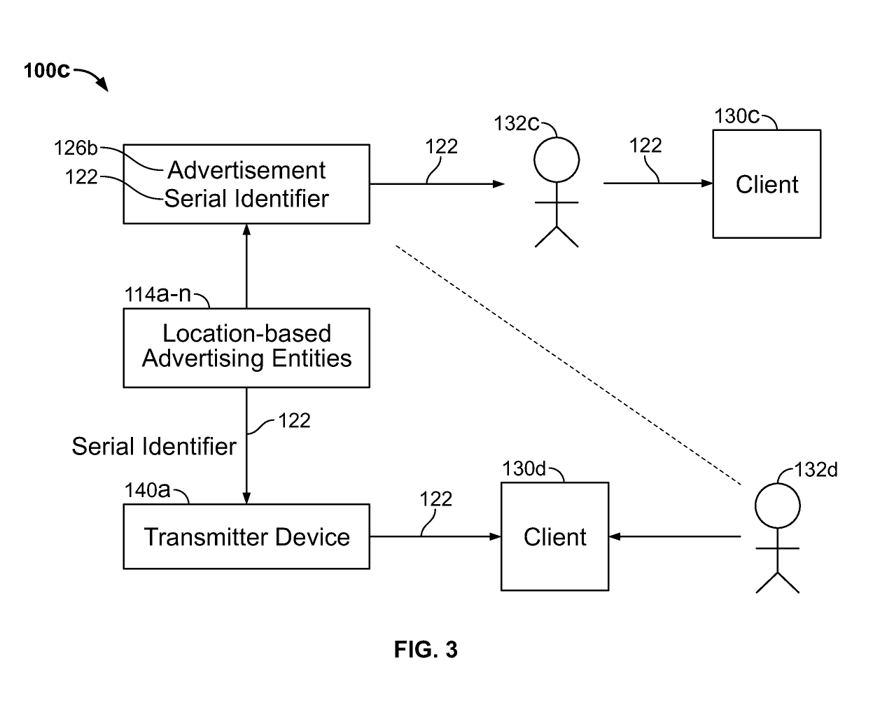

Referring now to FIG. 3, there is shown block diagram exemplifying an implementation of a system 100c that may be included as a component of the present technology. The system 100c may include several users 132c-d viewing a location-based advertisement 126b that may be provided by one or several location-based advertising entities 114a-n. The serial identifier 122 associated with the location-based advertisement 126b is displayed within, or otherwise delivered alongside, the location-based advertisement 126b. One user 132c views the location-based advertisement 126b and expresses interest or disinterest concerning the advertisement 126b by manually inputting the serial identifier 122 into a client device 130c, for example by typing data via a keypad or touchscreen interface, speaking in to a microphone, or capturing a photographic image. Another user 132d utilizes a client device 130d which receives the serial identifier 122 from a wireless transmitter device 140a that is placed within or nearby the location where the location-based advertisement 126b is displayed. The method of communication between the transmitter device 140a and the client device 130d is not limited by the embodiment of the present technology, but may include utilization of a short wavelength radio transmission technology such as Bluetooth™.

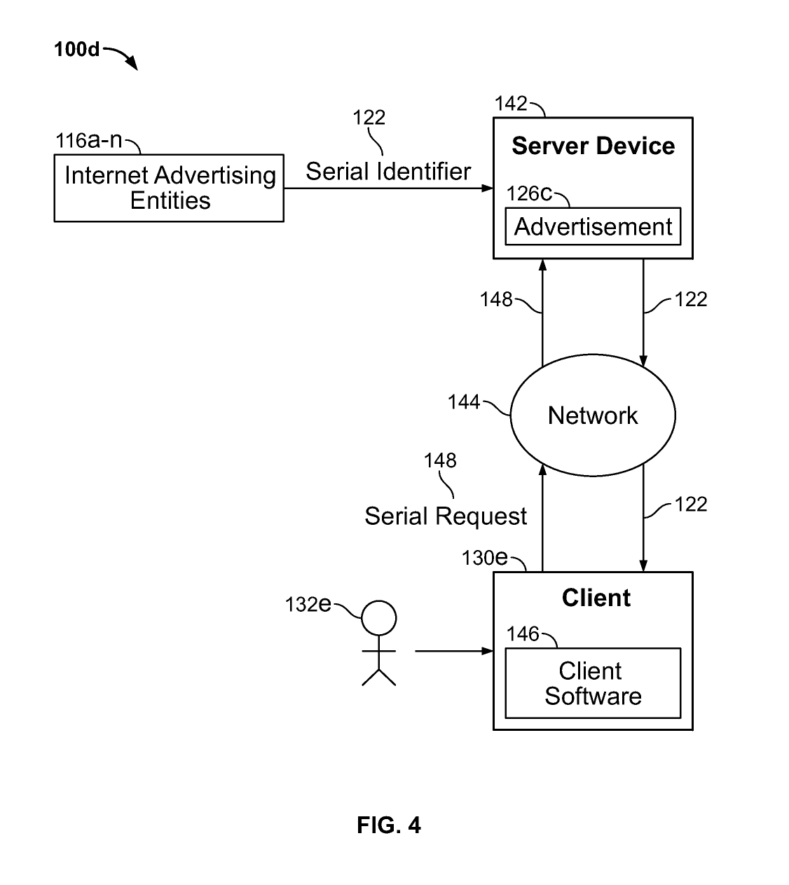

Referring now to FIG. 4, there is shown block diagram exemplifying an implementation of a system 100d that may be included as a component of the present technology. The system 100d may include a user 132e utilizing a client device 130e that executes an application program client software 146. The client 130e connects through a network 144 to a server device 142, on which resides an internet advertisement 126c that has been previously delivered to the server device, along with its associated serial identifier 122, by one or several internet advertising entities 116a-n. The network 144 may be any network involving two or more client devices and server devices; the network 144, as shown in FIG. 4, is the Internet. The user 132e, when viewing the Internet advertisement 126c through the network 144, may express interest or disinterest in the Internet advertisement 126c by sending a serial request 148 through the network 144 to the server device 142. The server device 142 subsequently sends the serial identifier 122 associated with the advertisement 126c through the network 144 to the client 130e, where it is received and handled by the client software 146.

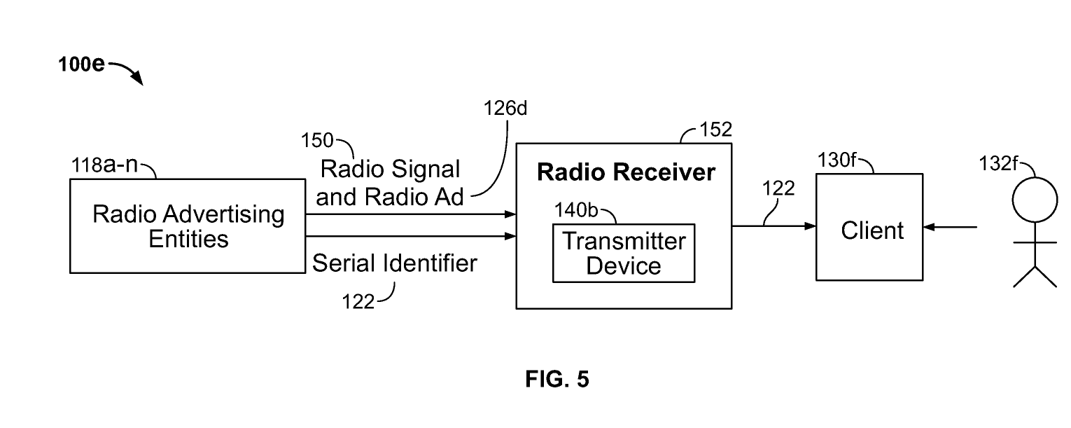

Referring now to FIG. 5, there is shown block diagram exemplifying an implementation of a system 100e that may be included as a component of the present technology. The system 100e may include a user 132f obtaining information from a radio signal 150 that is received by a radio receiver device 152. One or several radio advertising entities 118a-n deliver a radio advertisement 126d and its associated serial identifier 122 through the radio signal 150 to the user's 132f radio receiver 152. The methods for delivering the serial identifier 122 with the radio advertisement 126d are not limited by the embodiment of the present technology, but may include a multiplexed radio signal, or encoding within a digital radio signal. The user 132f may express interest or disinterest concerning the radio advertisement 126d by interacting with the radio receiver 152 that contains or otherwise interfaces with a transmitter device 140b, which sends the serial identifier 122 to the user's 132/client device 130f. The method of communication between the transmitter device 140b and the client device 130f is not limited by the embodiment of the present technology, and may include utilization of a short wavelength radio transmission technology such as Bluetooth T.

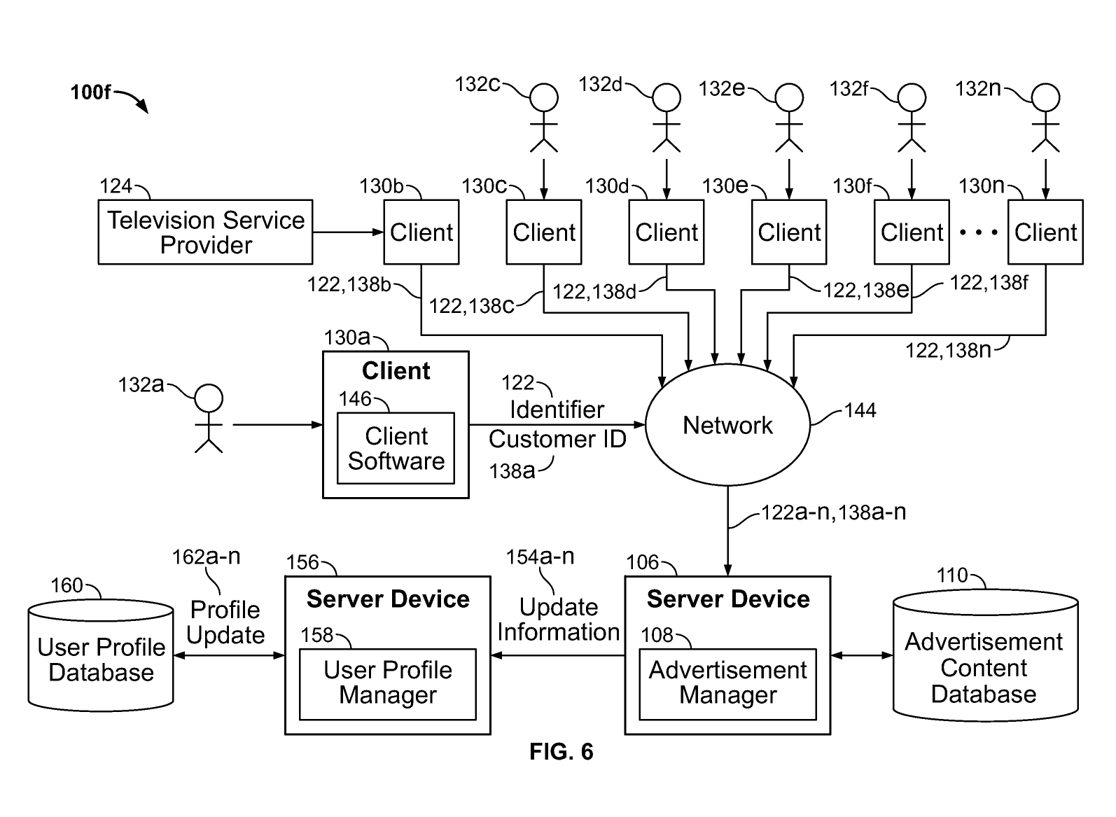

Referring now to FIG. 6, there is shown block diagram exemplifying an implementation of a system 100f that may be included as a component of the present technology. The system 100f may include the several users 132a-n and a television service provider 124 employing client devices 130a-n that each execute the client software 146 to communicate with a server device 106 through the network 144. The client devices 130a-n, after receiving the serial identifier 122 through any of the systems 100b-e of FIGS. 2-5, transmit the serial identifier 122 and respective customer identification codes 138a-n of the users 132a-n through the network 144 to the server device 106 that executes the advertisement manager application 108.

The advertisement manager 108 accesses the advertisement content database 110 and determines which advertiser 102a-n and which advertisement 126a-n is referenced by the serial identifier 122. Subsequently, the advertisement manager 108 transmits update information 154 to another server device 156 that executes a user profile manager application program 158. The update information 154 includes, but is not limited to, the serial identifier 122, associated advertiser 102a-n, associated advertisement 126a-b, and user profile identifications 138a-n. The user profile manager 158 accesses a user profile database 160 containing information that includes, but is not limited to, any serial identifiers 122 to which each user 132a-n has requested at any point in time. A profile update 162a-n performed by the profile manager 158 updates the user profile database 160 with the update information 154.

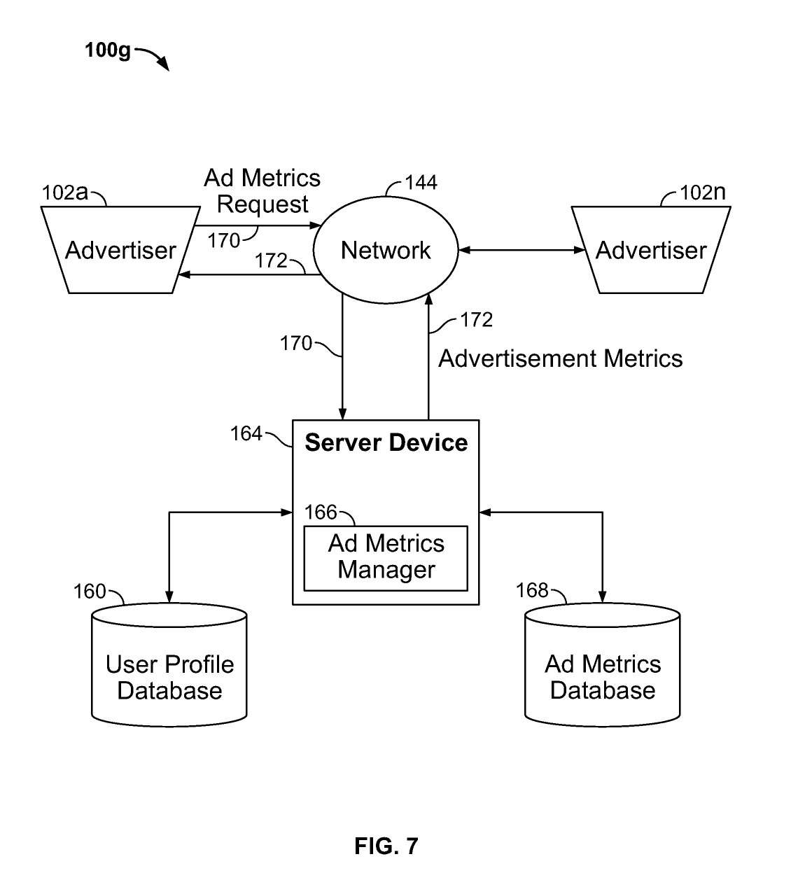

Referring now to FIG. 7, there is shown block diagram exemplifying an implementation of a system 100g that may be included as a component of the present technology. The system 100g may include several advertisers 102a-n that connect through a network 144 to a server device 164 that executes an advertisement metrics manager application program 166. The ad metrics manager 166 accesses the user profile database 160 and uses the information stored within to generate advertisement metrics 172 relating to the users 132a-n. These advertising metrics 172 may include, but are not limited to, the behaviors and interests of the users 132a-n relating to advertisements displayed in a multitude of environments including television, location-based, Internet, and radio advertising platforms. After generating these advertising metrics 172, the ad metrics manager 166 stores these metrics 172 for each advertiser 102a-n within an advertisement metrics database 168.

The advertisers 102a-n may send an advertisement metrics request 170 through the network 144 to the server device 164, which executes the ad metrics manager 166 and accesses the ad metrics database 168. The ad metrics manager 166 gathers the requested 170 ad metrics 172, and transmits the ad metrics 172 through the network 144 to the advertiser 102a-n.

Referring to FIGS. 1-7, in an aspect of the present disclosure, the systems 100a-g may perform a coordinated process as follows. An advertiser 102a wishes to collect advertisement metrics 172 for a collection of advertisements 126a-n that reference a similar or identical item or service. The advertiser 102a requests a serial identifier 122 from the serial identifier generator 104, which generates a unique serial identification 122 for the advertisements 126a-n. The serial identifier generator 104 then sends selected information concerning the advertiser 102a, the advertisements 126a-n, and the associated serial identifier 122 to a server device, which executes an advertisement manager application IOS and stores the information and identifier 122 in an advertisement content database 110. The serial identifier generator 104 then transmits the unique serial identifier 122 to the advertiser 102a.

When the advertiser 102a delivers their advertisements 126a-n to advertising entities (112-118)a-n, they also deliver the unique serial identifier 122 referencing those advertisements. The advertising entities (112-118)a-n then deliver the advertisements 126a-n to users 132a-n through various methods that include, but are not limited to, televisions, radios, movie theaters, the Internet, and the like. The users 132a-n, if they would like to express interest or disinterest in the advertisements 126a-n and their content, may request that the serial identifier 122 associated with those advertisements 126a-n be linked with their user accounts stored in the user profile database 160. The method for delivering the serial identifier 122 to the users 132a-n may include any of the systems 100b-e outlined in FIGS. 2-5, and will depend on the context in which users 132a-n view the advertisements 126a-n.

Whatever system 102b-e employed to receive the serial identifier 122, client devices 130a-n executing a client application program 146 subsequently transmit the users' 132a-n unique identification numbers 138a-n, along with the serial identifier 122, through a network 144 to a server device 106 that, using an advertisement manager application IOS, matches the serial identifier 122 to the advertiser's 102a information stored in the advertisement content database 110. The advertisement manager application IOS then transfers the users' 132a-n identification numbers 13Sa-n, along with information taken from the advertisement content database 110, to another server device 156. This server device runs a user profile manager application 158 that utilizes the update information 154a-n from the advertisement manager IOS to update the information on the users' 132a-n individual profiles 162a-n on the user profile database 160. These profiles 162a-n now reflect that the users 132a-n have expressed interest, or perhaps disinterest, in the advertisements 126a-n associated with the serial identifier 122.

The advertiser 102a, at a later time, accesses an advertisement metrics manager application 166 running on a server device 164. Using the ad metrics manager 166, the advertiser can view, store, and analyze metrics 172 stored on an advertisement metrics database 16S. These advertisement metrics 172 are compiled from the user profile database 160, and reflect the response of the users 132a-n to the advertisements 126a-n across several advertising platforms and environments. It should be noted that the present technology may comprise systems with different architectures than that which are presented in FIGS. 1-7.

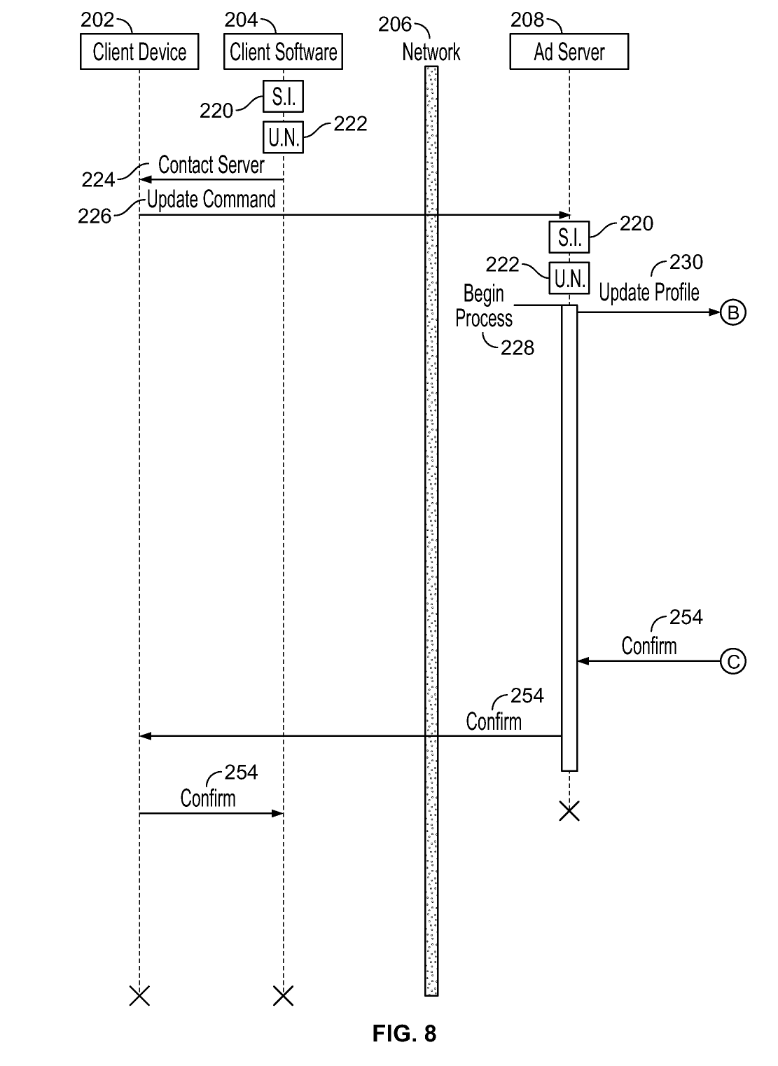

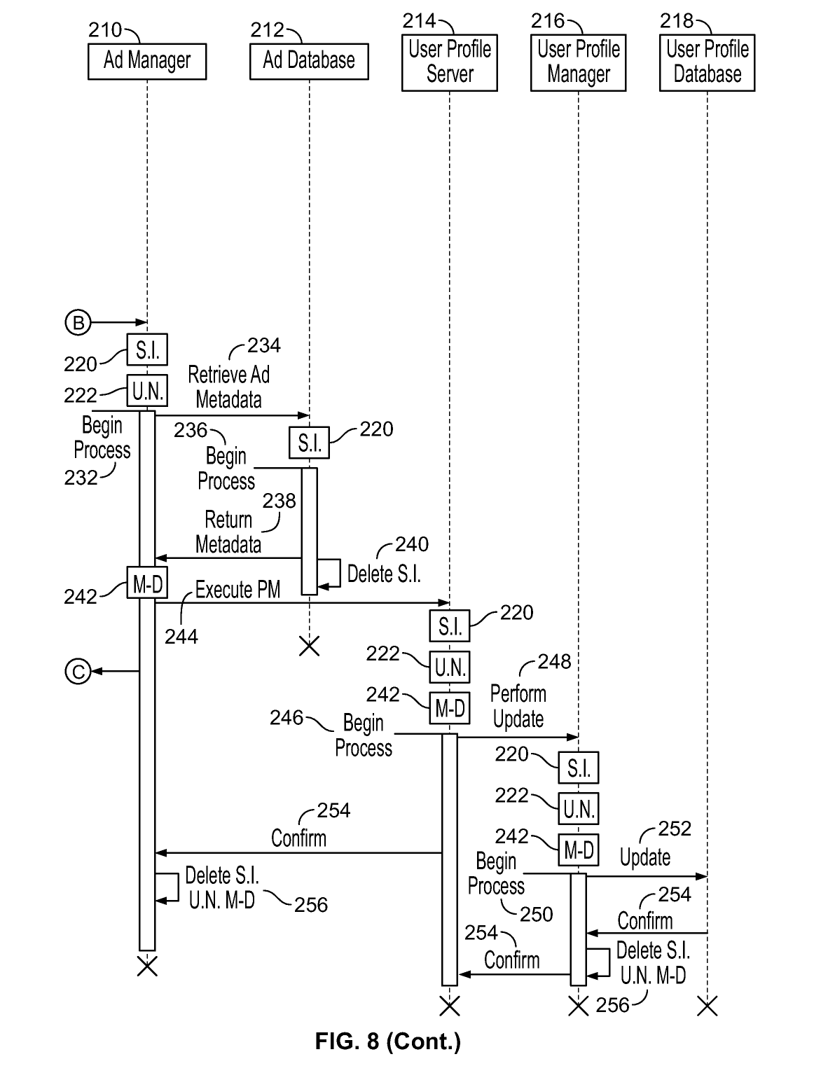

Referring now to FIG. 8, there is shown a sequence diagram illustrating the time-based flow of operations in one embodiment of the present technology. The diagrams include multiple lifelines, depicted as rectangular boxes with vertical dashed lines descending from their bottom edge, which represent objects that may undertake actions such as sending or receiving messages, or may be acted upon by other objects. Lifelines are ended by two crossed diagonal lines, at which point the lifeline no longer actively participates in the system illustrated by FIG. 8. Actions and messages are depicted by horizontal lines, ended by arrows, that originate from one lifeline and extend to another. Actions and messages placed lower (meaning nearer to the bottom of the page) on a lifeline occur at a later time than those placed above. A process undertaken by a lifeline is represented by a blank rectangular box, superimposed over a lifeline for the duration that the process occurs. Vertical and rectangular gray boxes depict separators, such as the Internet, that represent boundaries between lifelines. Messages that end in line arrows-as opposed to solid arrows-are asynchronous messages, which are sequenced accurately with respect to the lifeline on which they end but not, but asynchronous from the rest of the system.

Referring to FIG. 8, a system incorporating a client device 202, executing a client software application program 204, directly or indirectly interacts with a functional group of servers, databases, and application programs, connecting to one or several of these objects through network 206. Any and all objects or processes contained within the depiction and the following description of FIG. 8 that are similarly or identically named and described, with respect to objects, systems, processes, users, and other elements mentioned in the descriptions of FIGS. 1-7, may be, for example, similar or identical in function and form.

The client software 204, having received a serial identifier (SI) 220 and a user number (UN) 222 associated with a user of the client device 202, begins a sequence to update a user profile by commanding the client device 202 to contact an advertisement content server (ad server) 208. The UN 222 is not limited to being a numeric identifier, and may include non-numeric identifying information. The client device 202 subsequently messages, through the network 206, an update command 226 to the ad server 208. The update command 226 contains at least, but not necessarily only, the SI 220 and UN 222. The ad server 208 subsequently begins a process 228 to manage the update request from the client device 202. The ad server 208 sends an update profile message 230, commanding the advertisement manager application program (ad manager) 210 to execute a user profile update process 232. The update profile message 230 includes at least the SI 220 and UN 222.

The ad manager 210 begins the update process 232 by commanding 234 an advertisement content database (ad database) 212 to retrieve advertisement content metadata (MD) 242 that is associated with the SI 220. The ad database 212 begins a process 236 that uses the SI 220 to find and retrieve the MD 242. The ad database 212 subsequently sends a return message 238 containing the MD 242 to the ad manager 210. Some time after this message 238 is sent, the ad database 212 performs a subroutine to delete 240 the SI 220 from its local memory, whereupon the ad database completes the search and retrieval process 236.

The ad manager 210, after receiving the MD 242, contacts a user profile server 214 with a command 244 to execute a profile manager application program (profile manager) 216. This command 244 includes the SI 220, UN 222, and MD 242. The profile server 214 then begins a process 246 to manage the update of the user profile. The profile server 214 executes the profile manager 216 with a command 248 to begin a profile update process 250. The profile manager 216 interfaces with a user profile database 218, sending the database 218 an update message 252, whereupon the SI 220 and MD 242 are stored in a user profile linked to the UN 222. After the SI 220 and MD 242 have been stored on the user profile within the profile database 218, the profile database 218 sends a confirmation message 254 to the profile manager 216. The profile manager 216 relays the confirmation message 254 to the user profile server 214, and then completes the profile update process 250 by executing a subroutine 256 to remove the SI 220, UN 222, and MD 242 from the profile server's 214 local memory.

The user profile server 214 consequently sends the confirmation message 254 to the ad manager 210, which then commands the ad server 208 to relay the confirmation message 254 through the network 208 to the client device 202. After relaying the confirmation message 254, the ad manager 210 finishes its update process 232 by performing a subroutine 256 to delete the SI 220, UN 222, and MD 242 from the ad server's 208 local memory. At this point in time, the user profile update system has been completed.

The advantages of the foregoing examples may include, without limitation, a novel collection of systems and methods for collecting user advertising metrics that are tracked and integrated across a variety of advertising platforms; systems and methods that give advertisers prompt and up-to-date access to advertising metrics; and methods for tracking and collecting user advertising data with minimal bandwidth loading through the use of data-efficient serial identifiers.

In broad embodiment, the present technology is a collection of systems and methods that facilitate the gathering and distribution of advertising data by providing metrics that are integrated across a multitude of advertising platforms and environments.

### Integrating Television and Internet Advertisement Content

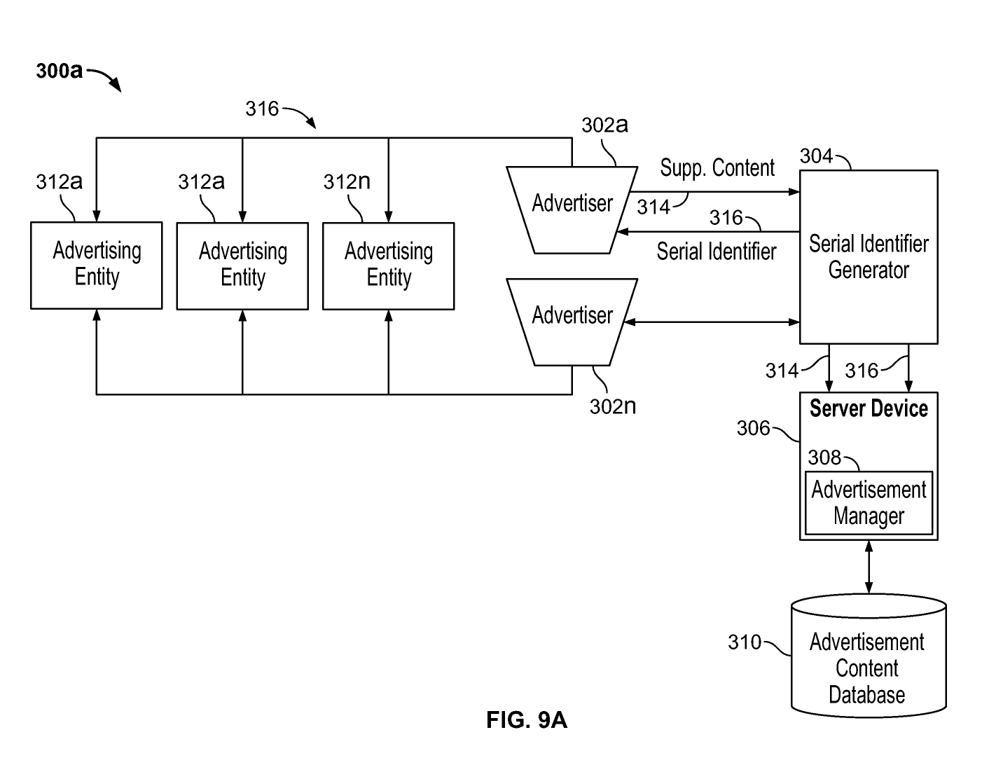

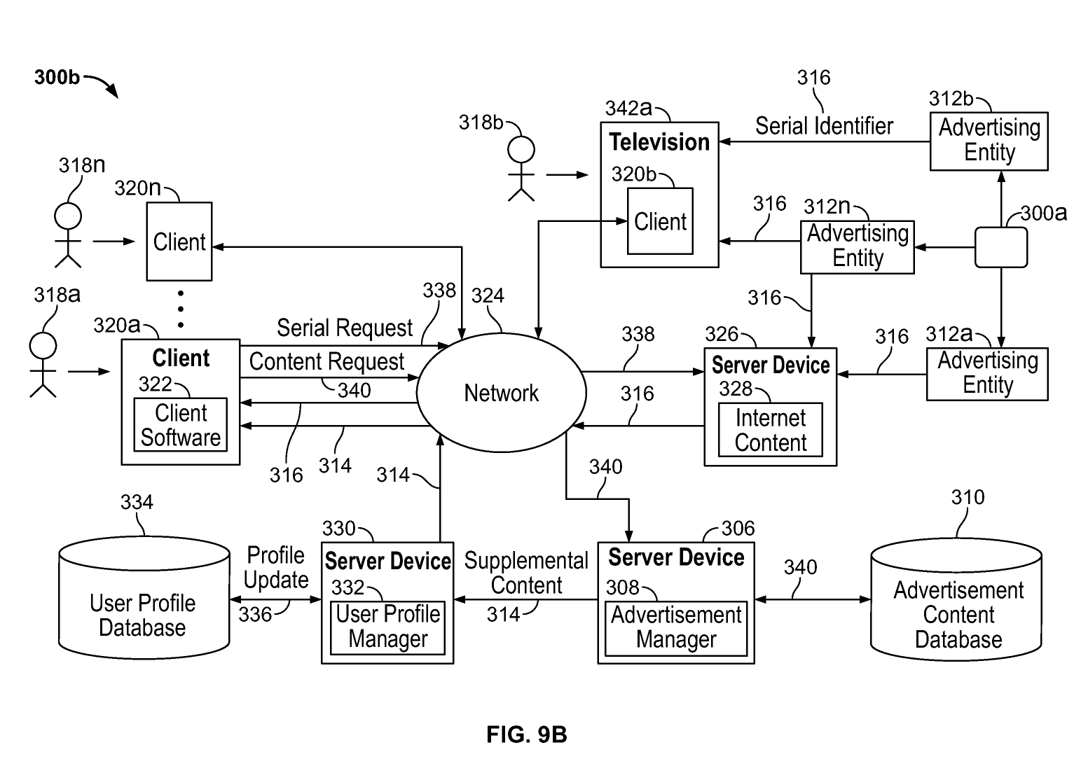

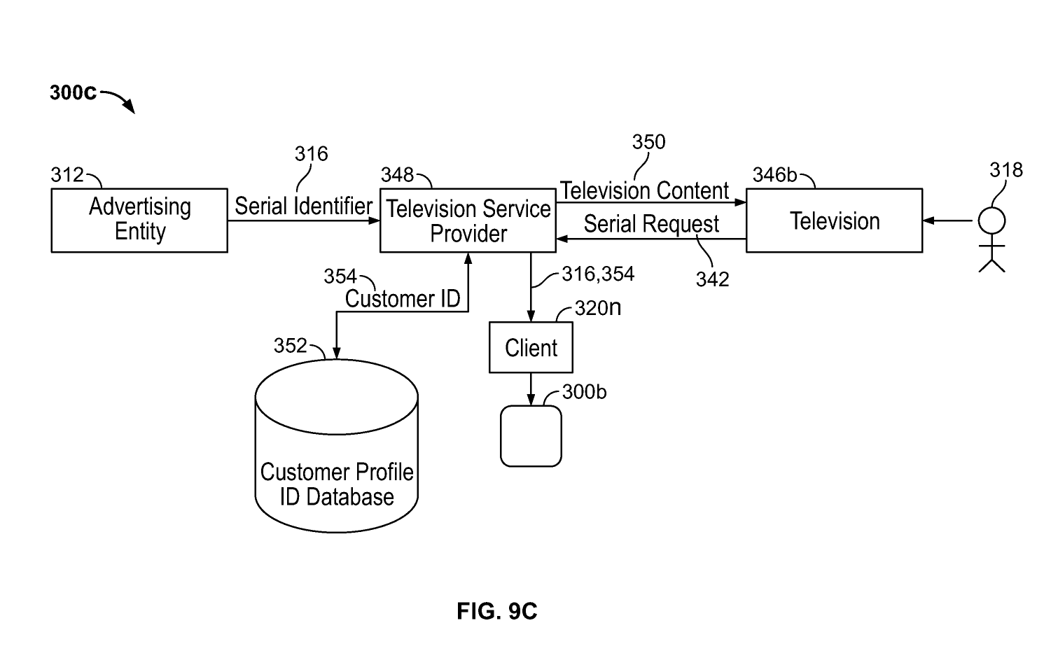

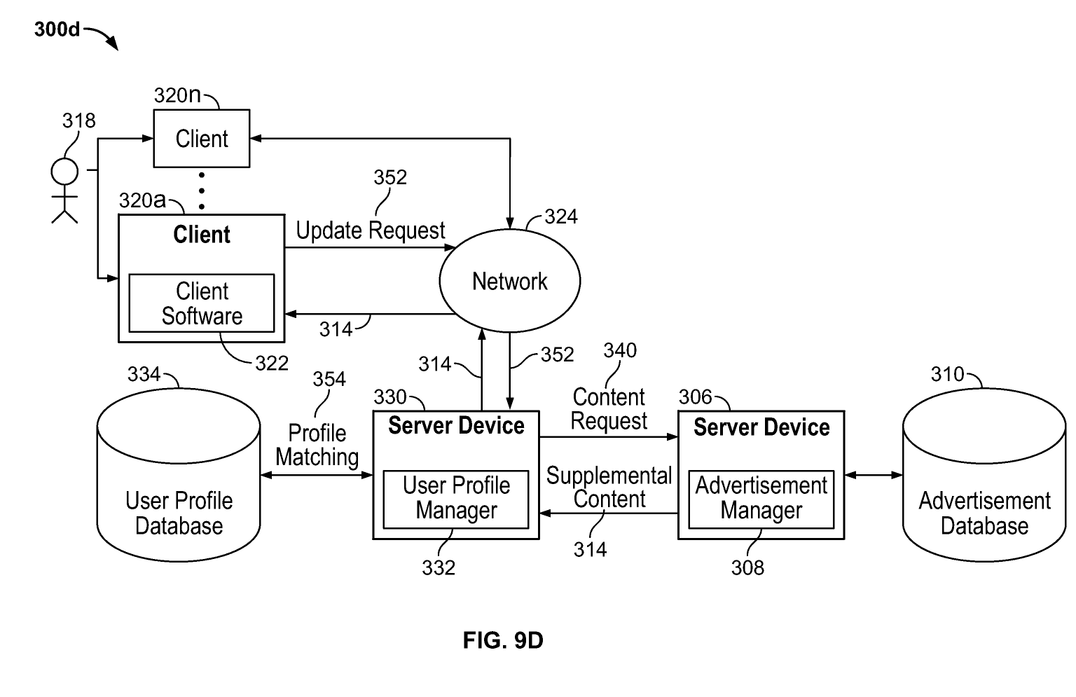

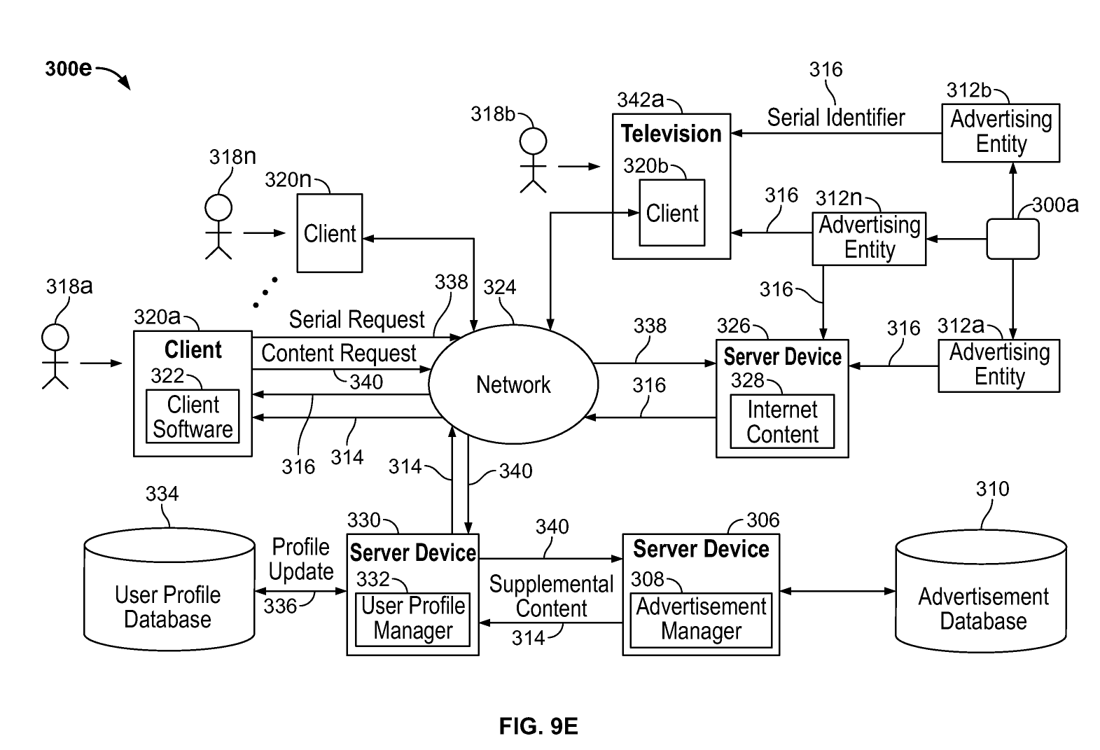

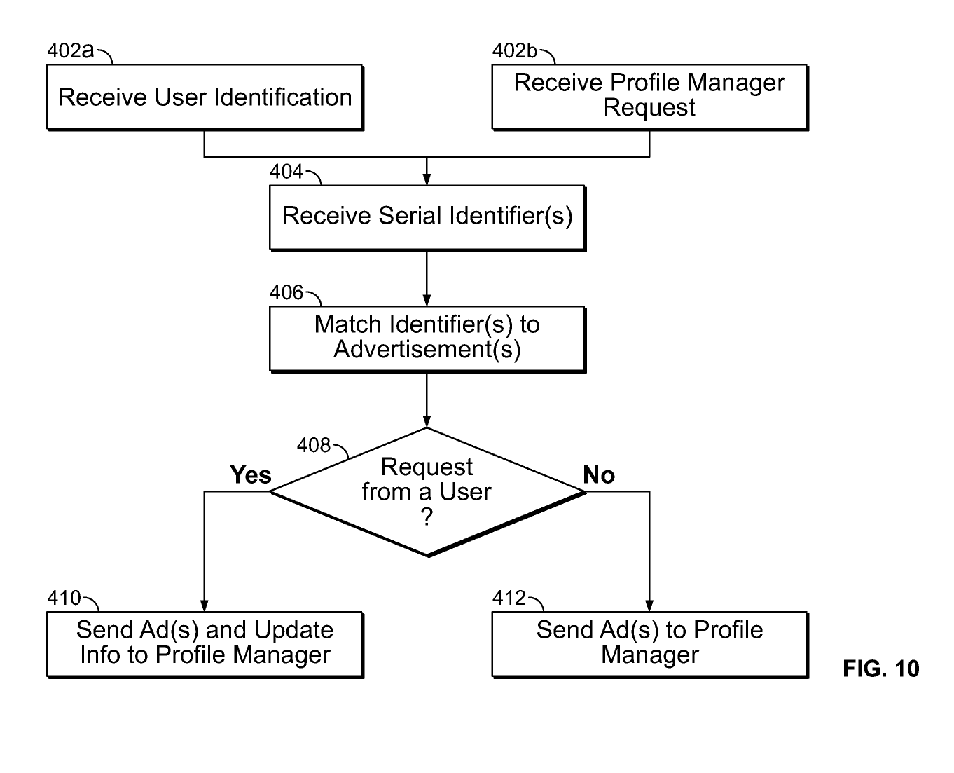

Referring now to drawings in which like numerals indicate like elements throughout the several figures, FIG. 9A is a block diagram exemplifying an implementation of a system for integrating television and internet advertisement content that may be included as a component of the present technology. The system 300a shown in FIG. 9A includes several advertisers 302a-n who wish to distribute supplemental advertisement content 314. These advertisers 302a-n include, but are not limited to, corporations and small businesses that desire to advertise goods or services in local, domestic, or international markets. The supplemental content 314 may include, but is not limited to, advertiser 302a-n contact information, pricing or other data relating to goods and services, and promotional offers such as barcode coupons for goods and services.

To begin distributing the supplemental content 314, an advertiser 302a first delivers the supplemental content 314 to a serial identifier generator 304 which creates a serial identifier 316 specifically identifying individual elements or collections of supplemental advertisement content 314. The serial identifier 316 may, but not must, be an identification code such as an alphanumeric serial number. A serial identifier generator 304 may be a digital device consisting of a processor, an electronic memory, and a digital data storage device, such as a personal computer. Implementations of the serial identifier generator 304 are not limited to this option, and may take other forms in different embodiments.

After creating a serial identifier 316, the serial identifier generator 304 delivers both the supplemental content 314 and its associated serial identifier 316 to a server device 306 that executes an advertisement content manager application program IOS. The advertisement manager IOS accesses an advertisement content database 310 that stores the supplemental content 314 along with its corresponding serial identifier 316. Through the advertisement content database 310, the advertisement manager IOS may access the supplemental content 314 at any time by searching the database 310 using the serial identifier 316 as an input. The advertisement manager IOS may also access supplemental content 314 through the advertisement content database 310 using other search methods and algorithms not limited by the embodiment of the present technology.

When the serial identifier generator 304 confirms that the supplemental content 314 and its associated serial identifier 316 have been stored in the database 310, the serial generator 304 delivers the serial identifier 316 that references the supplemental content 314 to the advertiser 302a. The advertiser 302a consequently delivers their advertisement and the serial identifier 316, but not the supplemental content 314 associated with the advertisement, to one or several advertising entities 312a-n. These advertising entities include, but are not limited to, agencies, corporations, or persons who sell or have direct or indirect access to advertising space on television networks, television programs, the internet, and the like.

Referring now to FIG. 9B, there is shown a block diagram of an aspect of the present disclosure, which illustrates a system 300b that includes several users I1Sa-n which utilize multiple client devices 320a-n that are in communication with server devices 326, 306, 330 through a network 324. The displayed network 324 includes the Internet; in other embodiments, other networks such as intranets may be used. Additionally, the systems and methods according to the present technology may operate within a single computer.

The displayed client devices 320a-n may include, but are not limited to, personal computers, mobile phones, cellular phones, smart phones, digital tablets, personal digital assistants, laptop computers, Internet appliances, and other processor-using digital platforms capable of interfacing directly or indirectly with the network 324, and capable of interacting with application programs. A client device 320b may also reside within, or as a component of, or otherwise interface with a television 342a. Client devices 320a-n include, for example, a digital tablet executing a browser application program such as Apple Computer, Inc.'s Safari™, or a personal computer executing a browser application program such as Apple Computer, Inc.'s Safari™ and Microsoft Corporation's Internet Explorer™.

Referring again to FIGS. 9A-B, the advertising entities 312a-n, after receiving advertisements and their associated serial identifiers 316 from advertisers 302a-n via the system 300a of FIG. 9A, deliver the advertisements and serial identifiers 316 to a server device 326 connected to the network 324, or to a television 342a. The processes used by the advertising entities 312a-n to deliver the advertisements and serial identifiers 316 to a television 342a or a server device 326 are not limited by the embodiment of the present technology and may include a network such as the network 324 shown, may be performed manually by the advertising entities 312a-n, or may include one or many intermediary entities, corporations, persons, or procedures.

Utilizing client devices 320a-n, users 318a-n may communicate over the network 324 with each other and with other systems and devices that are also linked to the network 324. A user 318a may, through the network 324, view content 328 that includes, but is not limited to, advertisements, which is located on the server device 326. Through the network 324 a user 318a may request supplemental material 314 associated with the viewed content 328 by using a client device 320a to execute an application program (software) 322, which through the network 324 sends a request 338 to obtain a serial identifier 316 from the server device 326. After receiving the serial request 338 through the network 324, the server device 326 delivers the serial identifier 316 associated with the viewed content 328 to the client device 320a, again by way of the network 324. When a client device 320b resides within, or is a component of, or otherwise interfaces with a television 342a, the serial identifier 316 may alternatively be delivered directly to the client device 320b through a television signal, without interacting with the server device 326 or networked content 328 through the network 324. After receiving a serial identifier 316 from a television signal, the client device 320b that resides within, or is a component of, or otherwise interfaces with a television 342a participates in the system 300b just as any other client device 320a-n.

The client device 320a executing client software 322 communicates a request 340 for supplemental content 314 to a different server device 306 through the network 324. The information contained within the supplemental content request 340 includes, but is not limited to, the serial identifier 316. The server device 306, after having received the content request 340, executes an advertisement content manager application program 308 that accesses the advertisement content database 310. The advertisement content database 310 contains the individual supplemental content elements 314 produced by the advertisers 302a-n that are each linked to their corresponding unique identifiers 316. The advertisement manager 308 uses the information contained within the content request 340 to extract the user-requested supplemental content 314 by matching the serial identifier 316 to the supplemental content 314.

The server device 306, after executing the advertisement manager 308 to obtain the supplemental content 314 from the advertisement content database 310, delivers the supplemental content 314 to another server device 330, either by way of an intranet or alternatively through the network 324. This server device 330 executes a user profile manager application program 332, which tracks and updates information concerning the users 318a-n, storing and sorting the information within a user profile database 334. This information includes, but is not limited to, any serial identifiers 316 to which a particular user 318a-n has requested access, for both current and prior executions of the system 300b.

After the user profile manager 332 executes a program to update 336 the user profile database 334 in order to reflect the user's 318a request for access to the supplemental content 314, the server device 330 delivers the supplemental content 314 to the client device 320a by way of the network 324. Thus, the user 318a now has access to the requested supplemental content 314. Notably, the user 318a may access the supplemental content 314 by saving and storing the supplemental content 314 on a client 320a or another storage device, and viewing the supplemental content 314 using the client 320a, or by employing the client 320a to view through the network 324 the supplemental content 314 stored on the advertisement database 310.

Referring now to FIG. 9C, there is shown a block diagram illustrating a system 300c of the present technology, which includes a user 318 operating a television 346b to view television content 350 that is delivered by a television service provider 348. The television service provider 348 may be, but is not limited to, any persons, corporations, or entities that deliver digital or analog television signals to customers, whether directly or through an intermediary. An example of a television service provider 348 may include a digital cable or satellite television provider, for example Verizon Communications Inc. or Comcast Corporation. The television content 350 includes any and all content delivered through an analog or digital signal to the television 346b, such as television shows, pay-per-view programming, games, programming menus, and any advertisements displayed in any context.

Referring now to FIGS. 9B-E, the television 346b shown in FIG. 9C has no client device 320a-n that resides within, or is a component of, or otherwise interfaces with the television 346b. Consequently, the television 346b has no method for accessing the network 324, and thus no way of directly requesting supplemental advertisement content 314 from a server device 326 that is also connected to the network 324, for example as shown in FIG. 9B. The system 300e of FIG. 9E allows the user 318 to request and receive supplemental advertisement content 314 using such a television 342b.

An advertising entity 312 who is to distribute an advertisement through television content 346 delivers a serial identifier 316 associated with that advertisement to a television service provider 348. The user 318, when viewing the advertisement as television content 350 on the television 346b, may receive supplemental advertising content 314 by making a request 342 to the television service provider 348 for the serial identifier 316 associated with the advertisement displayed within the television content 350. The methods for delivering the serial request 342 to the television service provider 348 are not limited by the embodiment of the present technology, but may include the utilization of Enhanced Binary Interchange Format (EBIF), or a channel within a multiplexed digital signal.

The television service provider 348, having received the user's 318 serial request 342, references a customer profile identification database 352 and retrieves a customer identification 354 identifying the user 318. Then, using a client device 320n, the television service provider 348 inputs both the requested serial identifier 316 and the user's 318 customer identification 354 into the system 300b of FIG. 9B, whereupon the user's 318 profile within the user profile database 352 is updated to reflect the request for the serial identifier 316. After the update 336 has been performed by the user profile manager 332, the user 318 may access the requested supplemental content 314 from any client device 320a-n by using the client software 322. Thus, the system 300c of FIG. 9C in conjunction with the system 300b of FIG. 9B allows users 318a-n to receive and access supplemental advertisement content 314 for advertisements viewed within television content 350, regardless of whether a client device 320a-n resides in, is a component of, or otherwise interfaces with the television 346b on which the television content 350 is viewed.

Referring now to FIG. 9D, there is shown a block diagram illustrating a system 300d of the present technology, which includes a single user 318 and multiple client devices 320a-n that communicate through the network 324 with a server device 330. The user 318, while using a client 320a, may execute client software 322 to send an update request 352 through the network 324 to the server device 330. The update request 352 may include data indicating which if any supplemental content 314 and associated serial identifiers 316 are stored within the client device 320a, or stored within any other storage device interfacing with the client 320a at the time that the update request 352 is sent; and which supplemental content 314 the user 318 has selected to remove from the client device 320a.

The server device 330 executes the user profile manager 332, which cross-references the information contained within the update request 352 with the information stored in the user profile database 334, in order to determine what, if any, supplemental content 314 and serial identifiers 316 are to be added or removed from the client 320a or any storage device interfacing with client 320a at the time of the update request 352. Additionally, the user profile manager 332 removes from the user profile database 334 any references within the user's 318 profile to supplemental content 314 that the user 318 has chosen to remove from the client device 320a, or any other storage device interfacing with the client device 320a. After determining which supplemental content 314 is associated with the user's 318 profile on the user profile database 334 but is not stored on the client device 320a or any storage device interfacing with client 320a, the user profile manager 332 sends a supplemental content request 340 including the corresponding serial identifier(s) 316 to a different server device 306, either through the network 324, an intranet network, or by some other method not limited by the embodiment of the present technology. This server device 306 executes the advertisement manager 308 to retrieve the supplemental content 314 from the advertisement content database 310, wherefore the server device 330 sends the retrieved supplemental content 314 to the user profile manager 332.

Through the network 324, the user profile server device 330 delivers the supplemental content 314 retrieved from the advertisement content database 310 to the client 320a and the client software 322. Additionally, the server device 330 commands the client software 322 to remove any supplemental content 314 not associated with the user's 318 profile on the user profile database 334 from the client device 320a, or any storage device interfacing with client 320a. Thus, the update request 352 resolves discrepancies between the supplemental content 314 accessible from the client device 320a and the supplemental content 314 that should be accessible by the user 318, as referenced by the user's 318 profile that is stored on the user profile database 334.

Therefore, the system 300d enables users 318a-n to access and view a personalized collection of supplemental advertising content 314 from any client device 320a-n, and also to make personal changes to that accessibility from any client device 320a-n. Moreover, the system 300d in conjunction with the systems 300b of FIG. 9B and 300c of FIG. 9C empower any user 318a-n to request and retrieve supplemental advertisement content 314 when viewing or interacting with any advertisement on a network 324 or within television content 346, and then view or interact with that supplemental advertising content 314 immediately or at a later time from any other client device I3Sa-n.

It should be noted that the present technology may comprise systems with different architectures than that which is presented in FIGS. 9B-D. For example, FIG. 9E displays an embodiment of the present technology with an alternative system architecture to that presented in FIG. 9B. Referring now to FIG. 9E, there is shown a system 300e wherein requests for supplemental information 314 from the client software 322 are sent through the network 324 to the profile manager server 330, rather than to the advertisement managing server 306 as in system 300b. Thus in this system 300e, the advertisement managing server 306 need not be connected to the network 324, only somehow connected to the profile manager server 330, whether through an intranet or by some other method.

Referring now to FIGS. 9B-C and FIG. 10, there is shown in FIG. 10 a flowchart exemplifying a method for retrieving user-requested advertising content from a database in one embodiment of the present technology. The advertisement managing server device 306 receives a request to execute the advertisement content manager IOS and retrieve supplemental content 314 from the advertisement content database 310. This request may come through the network 324 from the client software 322 as in system 300b, in which case the advertisement manager IOS receives a user identification 402a and serial identifier(s) 404; alternatively, this request may come from the user profile server device 330 either directly for through the network 324, in which case the advertiser manager receives a profile manager request 402b which includes the serial identifier(s) 404. After matching the serial identifier(s) 404 to its associated supplemental advertising content 406, the advertisement manager IOS to identify the supplemental content, the advertisement manager IOS sends the supplemental content to the user profile manager, either alone (if the request came from the profile server device) or with the user identification 402a and serial identifier(s) 404 (if the request came through the network from the client software). In this way, the users' profiles stored on the user profile database will accurately reference the supplemental content to which each respective user has requested access.

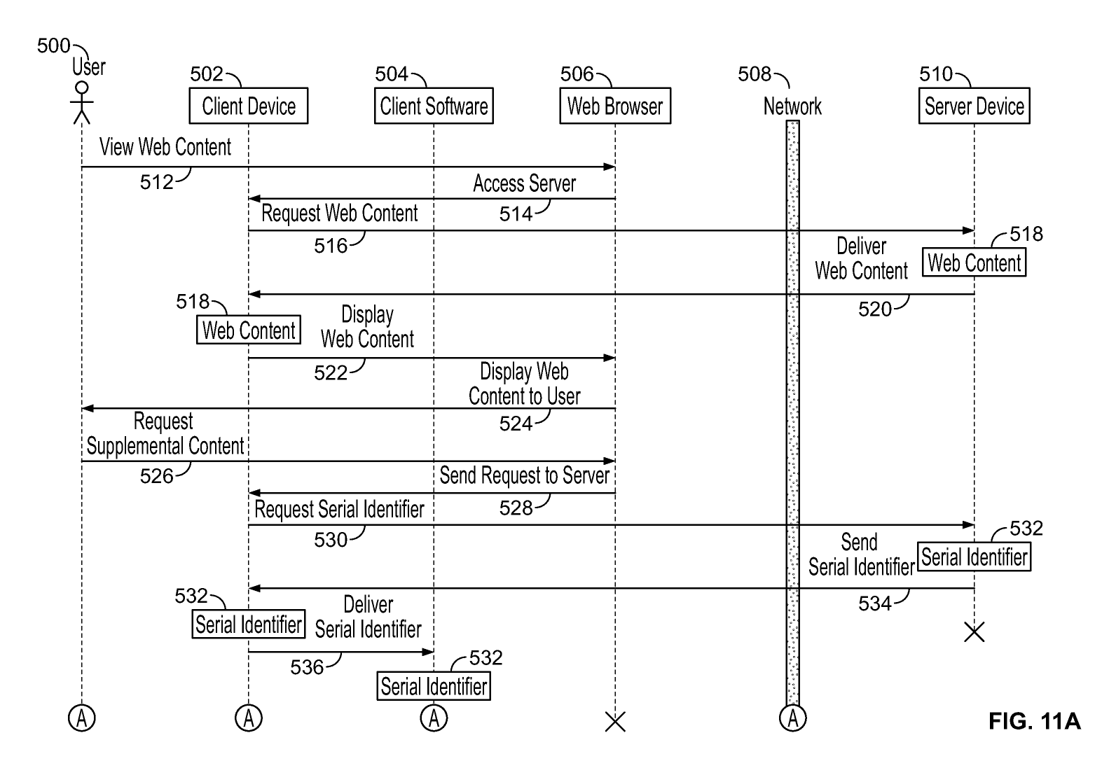

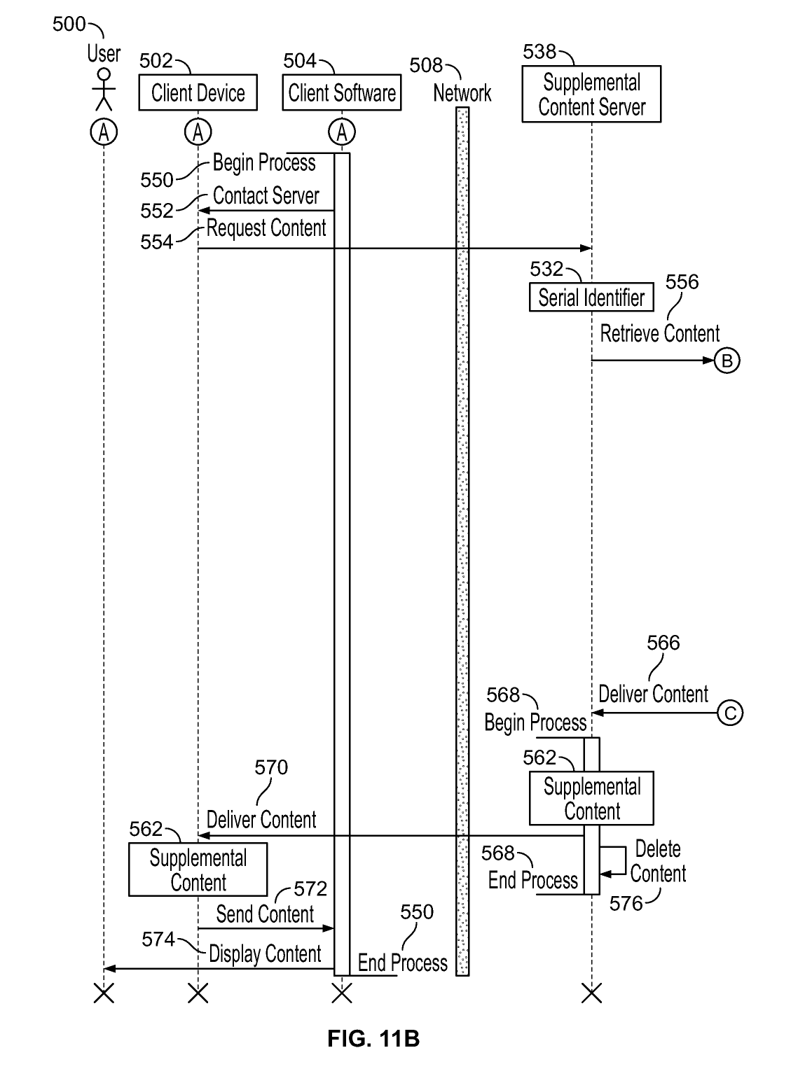

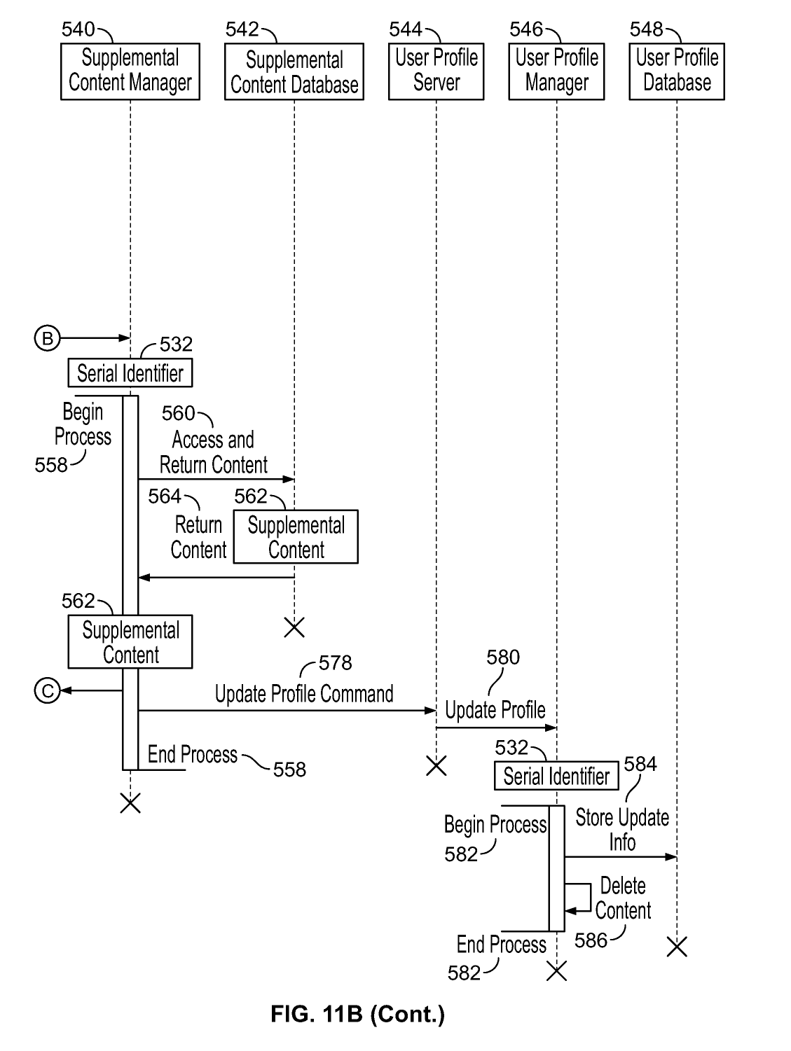

Referring now to FIGS. 11A-B there is shown a sequence diagram illustrating the time-based flow of operations in an aspect of the present disclosure. The diagrams include multiple lifelines, depicted as rectangular boxes with vertical dashed lines descending from their bottom edge, which represent objects that may undertake actions such as sending or receiving messages, or may be acted upon by other objects. Lifelines are ended by two crossed diagonal lines, at which point the lifeline no longer actively participates in the system illustrated by FIGS. 11A-B. Actions and messages are depicted by horizontal lines, ended by arrows, that originate from one lifeline and extend to another. Actions and messages placed lower (meaning nearer to the bottom of the page) on a lifeline occur at a later time than those placed above. A process undertaken by a lifeline is represented by a blank rectangular box, superimposed over a lifeline for the duration that the process occurs. Vertical and rectangular gray boxes depict separators, such as the Internet, that represent boundaries between lifelines.

Referring to FIG. 11A, a user 500 operates a client device 502 that executes a web browser application program, 506 and a client software application program 504. The user 500 interacts with the web browser 506 to utilize the client device's 502 hardware, which can connect to a server device 510 through a network 508 such as the Internet. To view content located on the server device 510, the user 500 sends a command 512 to the web browser 506, which subsequently messages 514 the client device 502, requesting access to the server device 510. The client device 502 then messages 516 the server device 510, through a network 508, requesting web content 518 desired by the user 500. The server device 510 then sends a reply message 520, which includes the web content 518, through the network 508 to the client device 502.

After receiving the web content 518, the client device 502 commands 522 the web browser 506 to format the web content 518, whereupon the web browser 506 displays 524 the web content 518 to the user 500. After viewing the web content 518, the user 500 sends a command 526 to the web browser 506 requesting additional materials associated with the web content 518. The web browser 506 subsequently messages 528 the client device 502, commanding that the client device 502 retrieve the user-requested materials from the server device 510. The client device 502, through the network 508, sends a message 530 to the server device 510 requesting the return of a serial identifier 532 associated with the web content 518. The server device 510 sends a reply message 534, containing the serial identifier 532, to the client device 502. After receiving the serial identifier 532, the client device 502 sends a message delivering 536 the serial identifier 532 to the client software 504. At this point in time, the server device 510 and web browser 506 are no longer participating in the system sequence.

Referring now to FIG. 11B, the sequence of FIG. 11A is continued. Having received the serial identifier 532, the client software 504 begins a process 550 to retrieve the supplemental materials requested by the user 500. The client software 504 sends a message 552 commanding the client device 502 to contact a supplemental content server 538. The client device 502 sends a request 554, containing the serial identifier 532, through the network 508 to the supplemental content server 538. The supplemental content server 538 executes a supplemental content manager application program 540. The supplemental content server 538 commands 556 the supplemental content manager 540 to retrieve the user-requested supplemental materials associated with the serial identifier 532. After receiving the serial identifier 532, the supplemental content manager 540 begins a process 558 to handle the request originating from the user 500. Using the serial identifier 532, the supplemental content manager 540 sends a search-and-return request 560 to the supplemental content database 542.

After locating the supplemental content 562 associated with the serial identifier 532, the supplemental content database 542 sends a return message 564, containing the supplemental content 562, to the supplemental content manager 540. The content manager 540 commands 566 the supplemental content server 538 to deliver the supplemental content 562 to the user 500. After receiving this command 536, the supplemental content server 538 begins a process 568 to deliver the supplemental content 562 to the user 500. The supplemental content server 538 delivers 570 the supplemental content 562 to the client device 502 through the network 508. The client device 502 then sends 572 the supplemental content 562 to the client software 504, which formats and displays 574 the supplemental content 562 to the user 500. This point marks the end of process 550.

Also depicted in the sequence diagram of FIG. 11B, there are messages and actions, denoted by horizontal lines and ending in line arrows instead of block arrows, which are messages and actions sequenced relative to each other, but possibly asynchronous to the rest of the system. Referring now to the lifeline of the supplemental content server 538, after delivering the supplemental content 562 to the client device 502, the supplemental content server 538 performs a deletion 576 of the supplemental content 562 from the supplemental content server's 538 local memory. The deletion 562 of the supplemental content 562 from the supplemental content server's 538 local memory marks the end of the process 568.

Referring now to the lifeline of the supplemental content manager 540, as a part of process 558 and after delivering the supplemental content 562 to the supplemental content server 538, the supplemental content manager 540 sends a user profile update command 578, including the serial identifier 532, to the user profile server 544 that executes a user profile manager application program 546. The user profile server 544 sends a profile update message 580 to the user profile manager 546, which then begins an update process 582. The user profile manager 546 performs an action 584 to store the profile update information, which includes the serial identifier 532 along with other information concerning the user 500, in the user profile database 548. After the profile update has been stored in the database 548, the user profile manager deletes 586 the serial identifier 522 and other contents of the update command 578 from the user profile server's 544 local memory. The deletion 586 action performed by the user profile manager 546 marks the end of the process 586.

The advantages of the technology for integrating television and internet advertisement content include, without limitation, a system that affords advertisers the ability to deliver user-requested supplemental advertisement content that is integrated with both television and network advertisements; a method for utilizing a central database and data-efficient serial identifiers to deliver user-requested content through a network or through a television signal, thus moving the majority of the bandwidth load away from advertisers, television service providers, and servers on which advertisements reside; systems and methods that permit users to independently receive, access, and utilize requested supplemental advertising content on any number of client devices; systems and methods that permit users to transport supplemental advertising content between televisions and network-enabled devices; and systems and methods that offer users the ability, through the use of mobile client devices, to easily transport requested content between locations.

In broad embodiment, the present technology includes a novel collection of systems and methods that grants advertisers the capability to deliver supplemental advertising content to their customers in a process that is integrated between both television and network advertisements. Furthermore, the present technology provides an environment for delivering supplemental advertising content, through both networks and television signals, that transports the burden of bandwidth-intensive operations from advertisers, and servers on which advertising content can be accessed-for example, Internet web sites-to a third party server with a central database.

### Delivering User-Requested Advertisement Content

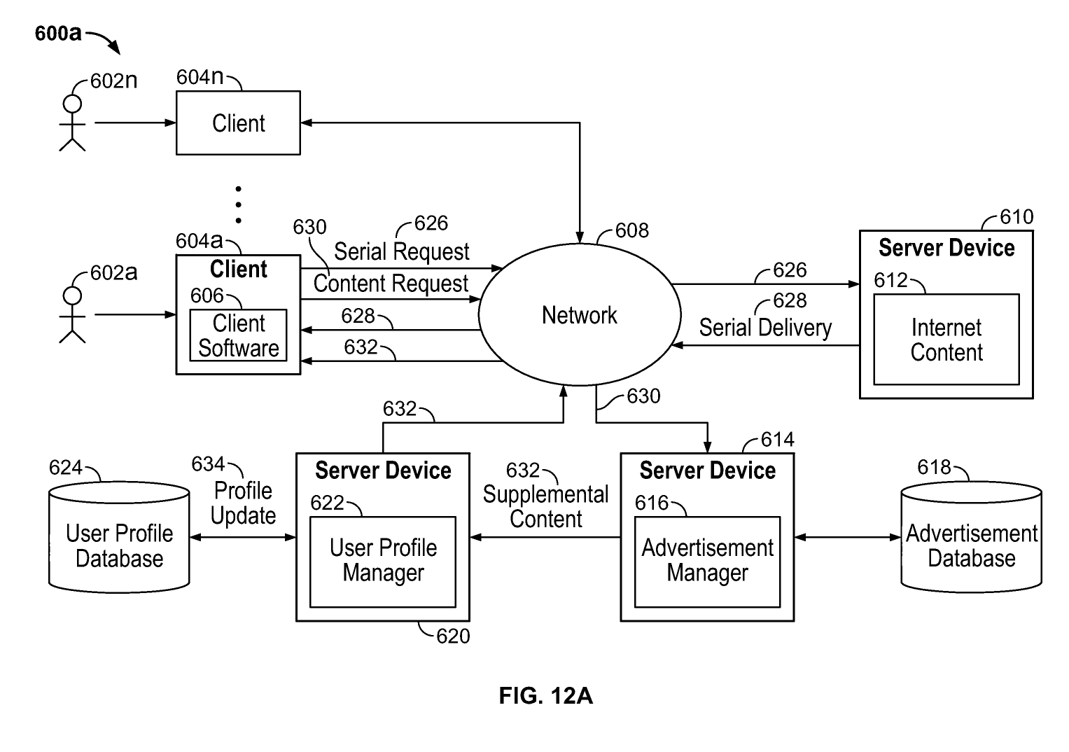

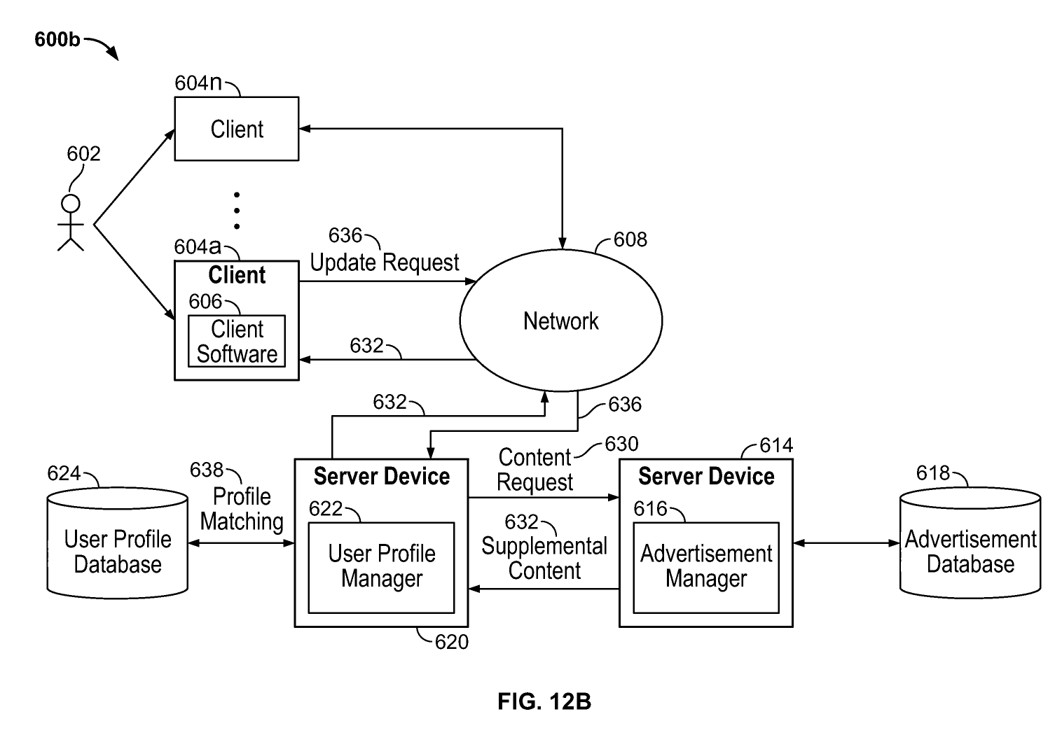

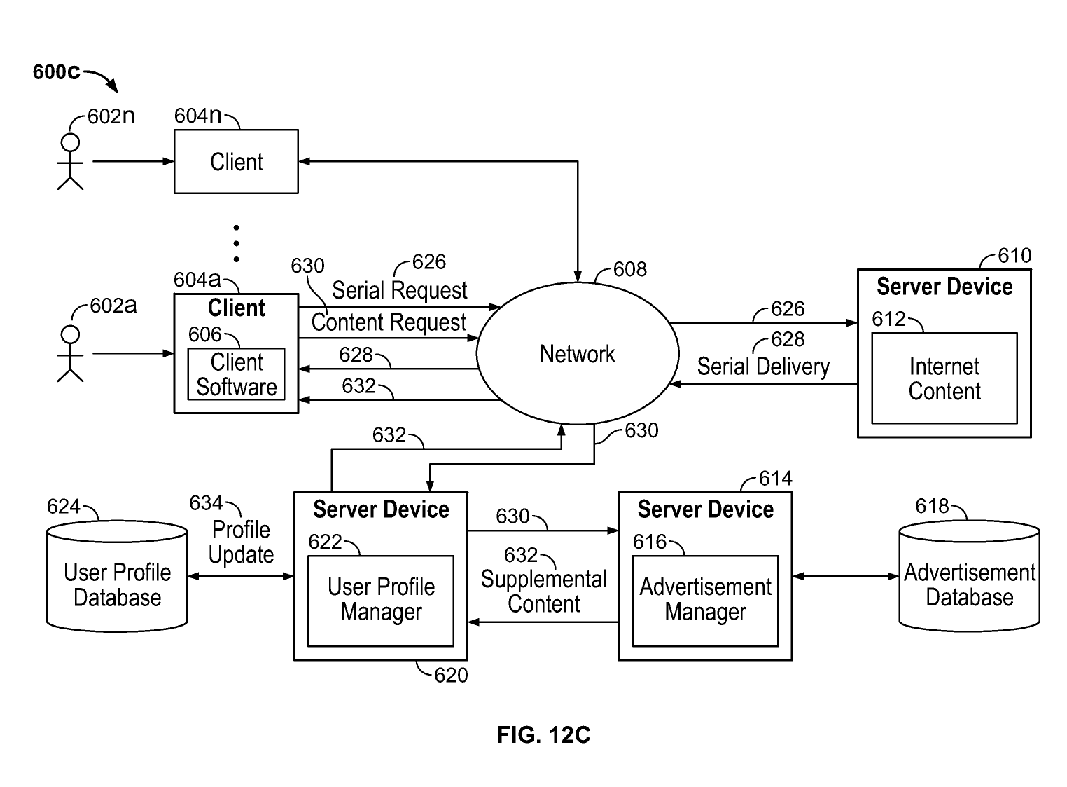

Referring now to drawings in which like numerals indicate like elements throughout the several figures, FIG. 12A is a block diagram exemplifying one system for delivering user-requested advertisement content according to an aspect of the present disclosure. The system 600a shown in FIG. 12A includes several users 602a-n which utilize multiple client devices 604a-n which are in communication with server devices 610, 614, 620 through a network 608. The displayed network 608 includes the Internet; in other embodiments of the present technology, other networks such as intranets may be used. Additionally, the systems and methods according to the present technology may operate within a single computer.

The displayed client devices 604a-n may include, but are not limited to, personal computers, mobile phones, cellular phones, smart phones, digital tablets, personal digital assistants, laptop computers, televisions, Internet appliances, and other processor-using digital platforms capable of interfacing directly or indirectly with the network IOS, and capable of interacting with application programs. Client devices 604a-n include, for example, a digital tablet executing a browser application program such as Apple Computer, Inc.'s Safari™, or a personal computer executing a browser application program such as Apple Computer, Inc.'s Safari™ and Microsoft Corporation's Internet Explorer™.

Utilizing client devices 604a-n, users 602a-n may communicate over the network IOS with each other and with other systems and devices that are also linked to the network IOS. A user 602a may, through the network IOS, view content 612 including but not limited to advertisements, which is located on the server device 610. Through the network IOS a user 602a may request supplemental material 632 associated with the content 612 by using a client device 604a to execute an application program (software) 606, which through the network IOS sends a request 626 to obtain a serial identifier 628 from the server device 610. The supplemental content 632 may include, but is not limited to, advertiser contact information, pricing or other data relating to goods and services, and promotional offers such as barcode coupons for goods and services. The serial identifier 628 may, but not must, be an alphanumeric serial number.

After receiving the serial request 626 through the network IOS, the server device 610 delivers the serial identifier 628 associated with the content 612 to the user 602a, again by way of the network IOS. The client device 604a executing client software 606 then communicates a request 630 for supplemental content 632 to a different server device 614 through the network IOS. The information contained within the supplemental content request 630 includes, but is not limited to, the serial identifier 628.

The server device 614, after having received the content request 630, executes an advertisement content manager application program 616 that accesses an advertisement content database 618. The advertisement content database 618 contains individual supplemental content elements 632 that are each linked to corresponding unique identifiers, of which the serial identifier 628 is a member. The advertisement manager 616 uses the information contained within the content request 630 to extract the user-requested supplemental content 632 by matching the serial identifier 628 to the supplemental content 632.

The server device 614, after executing the advertisement manager 616 to obtain the supplemental content 632 from the advertisement content database 618, delivers the supplemental content 632 to another server device 620, either by way of an intranet or alternatively through the network IOS. This server device 620 executes a user profile manager application program 622, which tracks and updates information concerning the users 602a-n, storing and sorting the information within a user profile database 624. This information includes, but is not limited to, identifiers for the advertising materials (such as supplemental content 632) and the corresponding serial identifiers (such as serial identifier 628) to which the users 602a-n have requested access.

After employing the user profile manager 622 to update 634 the user profile database 624 in order to reflect the user's 602a request for access to the supplemental content 632, the server device 620 delivers the supplemental content 632 to the client 604a by way of the network IOS. Thus, the user 602a now has access to the requested supplemental content 632. Notably, the user 602a may access the supplemental content 632 by saving and storing the supplemental content 632 on a client 604a or another storage device, and viewing the supplemental content 632 using the client 604a, or by employing a client 604a to view through the network 608 the supplemental content 632 stored on the advertisement database 618.

Referring now to FIG. 12B, there is shown a block diagram exemplifying another system of one embodiment of the present technology. The system 600b shown in FIG. 12B includes a single user 602 and multiple client devices 604a-n which communicate through the network 608 with a server device 620. The user 602, while using a client 604a, may execute client software 606 to send an update request 636 through the network 608 to the server device 620. The update request 636 is comprised of information that includes, but is not limited to: data indicating which if any supplemental content 632 and associated serial identifiers 628 are stored within the client device 604a, or stored within any other storage device interfacing with the client 604a at the time that the update request 636 is sent; and which supplemental content 632 the user 602 has selected to remove from the client device 604a.

The server device 620 executes the user profile manager 622, which cross-references the information contained within the update request 636 with the information stored in the user profile database 624, in order to determine what, if any, supplemental content 632 and serial identifiers 628 are to be added or removed from the client 604a or any storage device interfacing with client 604a at the time of the update request 636. Additionally, the user profile manager 622 removes from the user's 602 profile on the user profile database 624 any references to supplemental content 632 that the user 602 has chosen to remove from the client device 604a, or any other storage device interfacing with the client device 604a. After determining which supplemental content 632 is associated with the user's 602 profile but is not stored on the client device 604a or any storage device interfacing with client 604a, the user profile manager 622 sends a supplemental content request 630 including the corresponding serial identifier(s) 628 to a different server device 614, either through the network 608, an intranet network, or by some other method. This server device 614 executes the advertisement manager 616 to retrieve the supplemental content 632 from the advertisement content database 618, wherefore the server device 614 sends the retrieved supplemental content 632 to the user profile manager 622.

Through the network 608, the user profile server device 620 delivers the supplemental content 632 retrieved from the advertisement content database 618 to the client 604a and the client software 606. Additionally, the server device 620 commands the client software 606 to remove any supplemental content 632 not associated with the user's 602a profile on the user profile database 624 from the client device 604a, or any storage device interfacing with client 604a. Thus, the update request 636 resolves discrepancies between the supplemental content 632 accessible from the client device 604a and the supplemental content 632 that should be accessible by the user 602, as referenced by the user's 602 profile that is stored on the user profile database 624.

Therefore, the system 600a enables users 602a-n to access and view the uniform personalized supplemental advertising content 632 from any client device 604a-n, and also to make personal changes to that accessibility from any client device 604a-n. Moreover, system 600a in conjunction with system 600b empowers any user 602a-n to request and retrieve supplemental advertisement content 632 when viewing or interacting with any advertisement on a network 608, from any client device 604a-n, and then view or interact with that supplemental advertising content 632 immediately or at a later time from any other client device 604a-n.

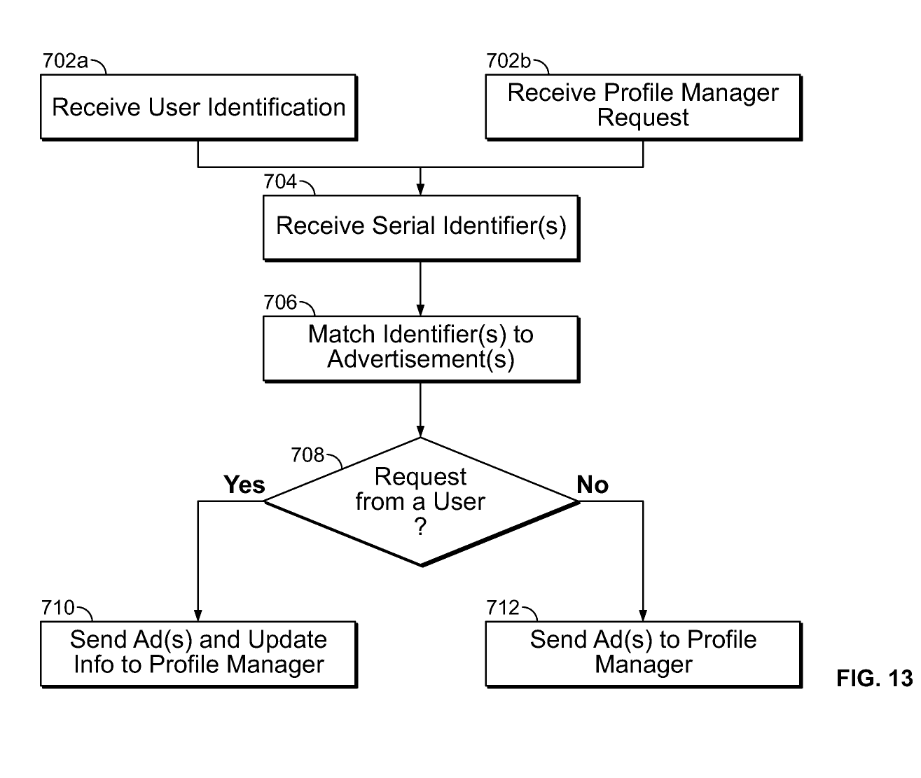

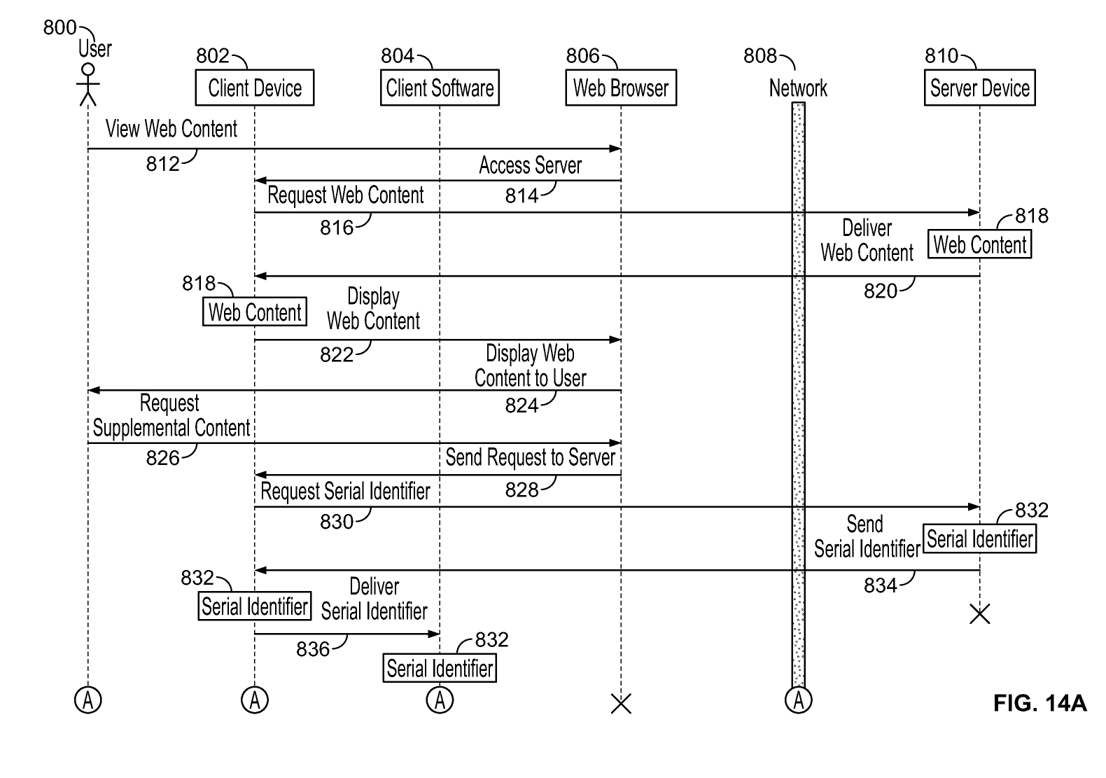

Referring now to FIG. 12A and FIG. 13, there is shown in FIG. 13 a flowchart exemplifying a method for retrieving user-requested advertising content from a database in one embodiment of the present technology. The advertisement managing server device 614 receives a request to execute the advertisement content manager 616 and retrieve supplemental content 632 from the advertisement content database 618. This request may come through the network 608 from the client software 606 as in system 600a, in which case the advertisement manager 616 receives a user identification 702a and serial identifier(s) 704; alternatively, this request may come from the user profile server device 620 either directly for through the network 608, in which case the advertiser manager receives a profile manager request 702b which includes the serial identifier(s) 704. After matching the serial identifier(s) 704 to its associated supplemental advertising content 706, the advertisement manager 616 sends the supplemental content 632 to the user profile manager 622, either alone (if the request came from the profile server device) or with the user identification 702a and serial identifier(s) 704 (if the request came through the network 608 from the client software 606). In this way, the users' 602a-n profiles stored on the user profile database 624 will always accurately reference which supplemental content 632 to which they have requested access.

It should be noted that the present technology may comprise systems with different architectures than that which is presented in FIGS. 12A-B. For example, FIG. 12C displays an embodiment of the present technology with an alternative system architecture to that presented in FIG. 12A. Referring now to FIG. 12C, there is shown a system 600c wherein all requests for supplemental information 632 from the client software 606 are sent through the network 608 to the profile manager server 620, rather than to the advertisement managing server 614 as in system 600a. Thus in this system 600c, the advertisement managing server 614 need not be connected to the network 608, only somehow connected to the profile manager server 620, whether through an intranet or by some other method.

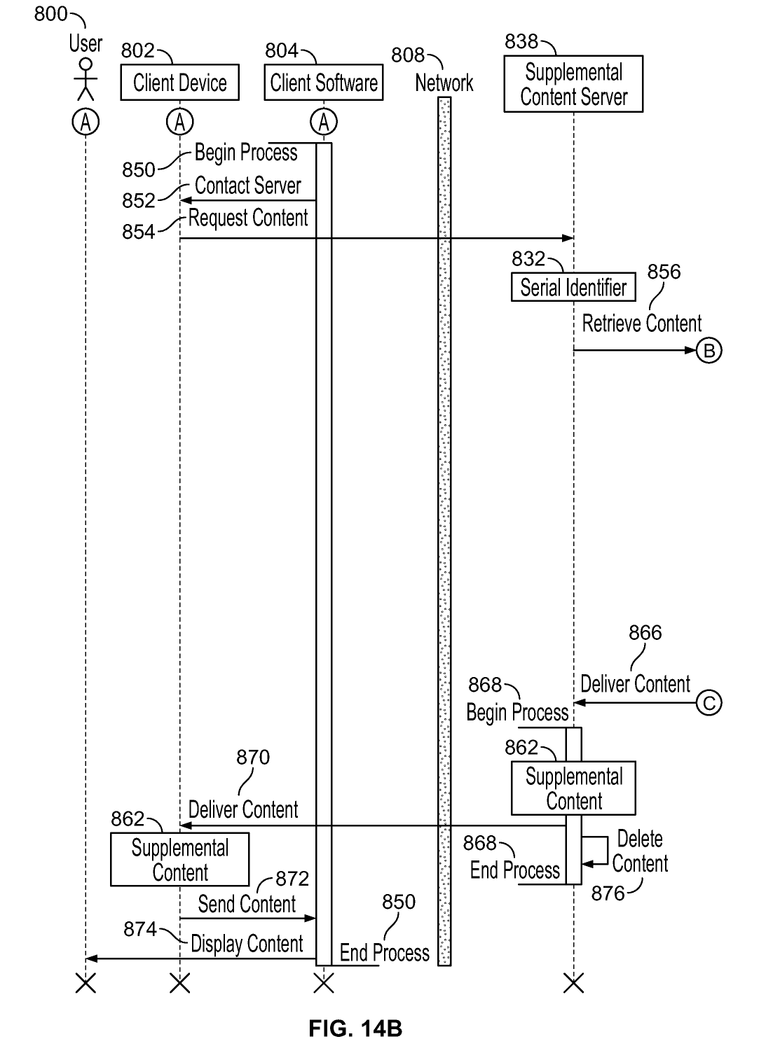

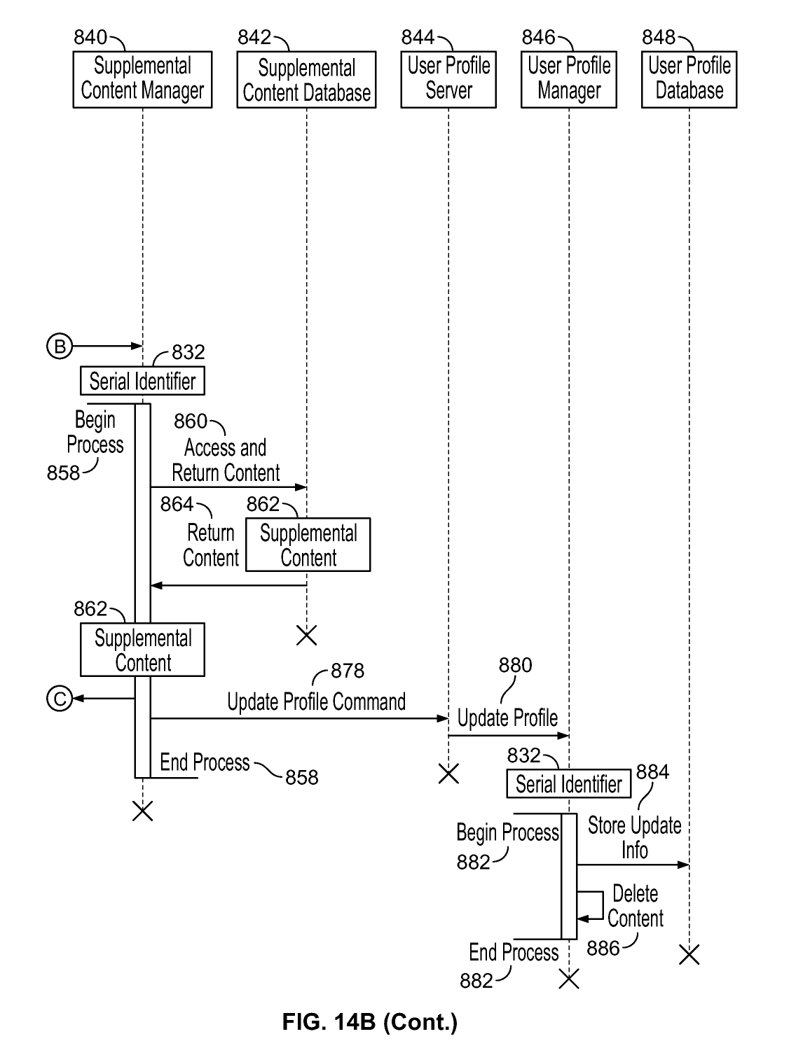

Referring now to FIGS. 14A-B there is shown a sequence diagram illustrating the time-based flow of operations in another aspect of the present disclosure. The diagrams include multiple lifelines, depicted as rectangular boxes with vertical dashed lines descending from their bottom edge, which represent objects that may undertake actions such as sending or receiving messages, or may be acted upon by other objects. Lifelines are ended by two crossed diagonal lines, at which point the lifeline no longer actively participates in the system illustrated by FIGS. 14A-B. Actions and messages are depicted by horizontal lines, ended by arrows, that originate from one lifeline and extend to another. Actions and messages placed lower (meaning nearer to the bottom of the page) on a lifeline occur at a later time than those placed above. A process undertaken by a lifeline is represented by a blank rectangular box, superimposed over a lifeline for the duration that the process occurs. Vertical and rectangular gray boxes depict separators, such as the Internet, that represent boundaries between lifelines.

Referring to FIG. 14A, a user 800 operates a client device 802 that executes a web browser application program, 806 and a client software application program 804. The user 800 interacts with the web browser 806 to utilize the client device's 802 hardware, which can connect to a server device 810 through a network 808 such as the Internet. To view content located on the server device 810, the user 800 sends a command 812 to the web browser 806, which subsequently messages 814 the client device 802, requesting access to the server device 810. The client device 802 then messages 816 the server device 810, through a network 808, requesting web content 818 desired by the user 800. The server device 810 then sends a reply message 820, which includes the web content 818, through the network 808 to the client device 802.

After receiving the web content 818, the client device 802 commands 822 the web browser 806 to format the web content 818, whereupon the web browser 806 displays 824 the web content 818 to the user 800. After viewing the web content 818, the user 800 sends a command 826 to the web browser 806 requesting additional materials associated with the web content 818. The web browser 806 subsequently messages 828 the client device 802, commanding that the client device 802 retrieve the user-requested materials from the server device 810. The client device 802, through the network 808, sends a message 830 to the server device 810 requesting the return of a serial identifier 832 associated with the web content 818. The server device 810 sends a reply message 834, containing the serial identifier 832, to the client device 802. After receiving the serial identifier 832, the client device 802 sends a message delivering 836 the serial identifier 832 to the client software 804. At this point in time, the server device 810 and web browser 806 are no longer participating in the system sequence.

Referring now to FIG. 14B, the sequence of FIG. 14A is continued. Having received the serial identifier 832, the client software 804 begins a process 850 to retrieve the supplemental materials requested by the user 800. The client software 804 sends a message 852 commanding the client device 802 to contact a supplemental content server 838. The client device 802 sends a request 854, containing the serial identifier 832, through the network 808 to the supplemental content server 838. The supplemental content server 838 executes a supplemental content manager application program 840. The supplemental content server 838 commands 856 the supplemental content manager 840 to retrieve the user-requested supplemental materials associated with the serial identifier 832. After receiving the serial identifier 832, the supplemental content manager 840 begins a process 858 to handle the request originating from the user 800. Using the serial identifier 832, the supplemental content manager 840 sends a search-and-return request 860 to the supplemental content database 842.

After locating the supplemental content 862 associated with the serial identifier 832, the supplemental content database 842 sends a return message 864, containing the supplemental content 862, to the supplemental content manager 840. The content manager 840 commands 866 the supplemental content server 838 to deliver the supplemental content 862 to the user 800. After receiving this command 836, the supplemental content server 838 begins a process 868 to deliver the supplemental content 862 to the user 800. The supplemental content server 838 delivers 870 the supplemental content 862 to the client device 802 through the network 808. The client device 802 then sends 872 the supplemental content 862 to the client software 804, which formats and displays 874 the supplemental content 862 to the user 800. This point marks the end of process 850.

Also depicted in the sequence diagram of FIG. 14B, there are messages and actions, denoted by horizontal lines and ending in line arrows instead of block arrows, which are messages and actions sequenced relative to each other, but possibly asynchronous to the rest of the system. Referring now to the lifeline of the supplemental content server 838, after delivering the supplemental content 862 to the client device 802, the supplemental content server 838 performs a deletion 876 of the supplemental content 862 from the supplemental content server's 838 local memory. The deletion 862 of the supplemental content 862 from the supplemental content server's 838 local memory marks the end of the process 868.

Referring now to the lifeline of the supplemental content manager 840, as a part of process 858 and after delivering the supplemental content 862 to the supplemental content server 838, the supplemental content manager 840 sends a user profile update command 878, including the serial identifier 832, to the user profile server 844 that executes a user profile manager application program 846. The user profile server 844 sends a profile update message 880 to the user profile manager 846, which then begins an update process 882. The user profile manager 846 performs an action 884 to store the profile update information, which includes the serial identifier 832 along with other information concerning the user 800, in the user profile database 848. After the profile update has been stored in the database 848, the user profile manager deletes 886 the serial identifier 822 and other contents of the update command 878 from the user profile server's 844 local memory. The deletion 886 action performed by the user profile manager 846 marks the end of the process 886.

The advantages of the present technology include, without limitation, a system that affords advertisers the ability to deliver user-requested supplemental advertisement content through a network; a method for delivering user-requested content through a network that moves the majority of the bandwidth load away from advertisers, and servers on which advertisements appear, through the use of a central database and data-efficient serial identifiers; systems and methods that permit users to receive, access, and utilize requested supplemental advertising content on any number of client devices simultaneously; systems and methods that offer users the ability, through the use of mobile client devices, to easily transport requested content between locations.

In broad embodiment, the present technology is a novel collection of systems and methods that grants advertisers the capability to deliver supplemental advertising content to their customers through networks. Furthermore, the present technology provides an environment for delivering advertising content through networks that transports the burden of bandwidth-intensive operations from advertisers and servers on which advertising content can be accessed-for example, Internet websites-to a third party server with a central database.

### Delivering User-Requested Advertisement Information from Electronic Games

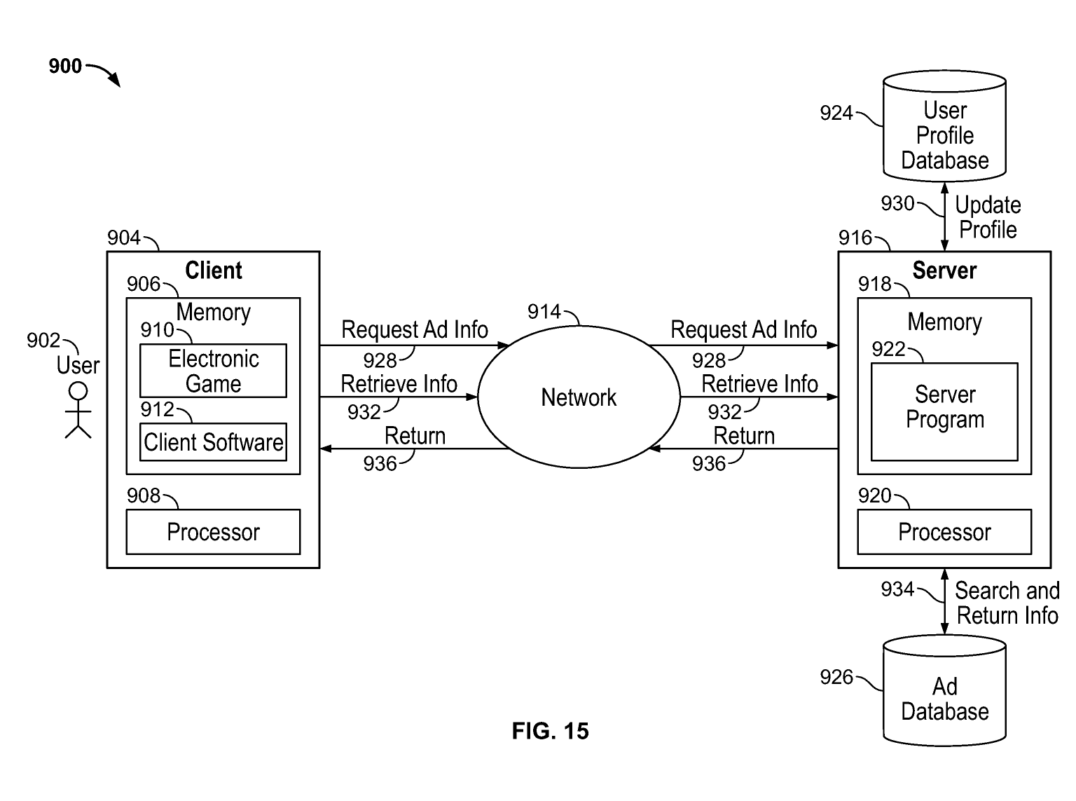

Referring now to drawings in which like numerals indicate like elements throughout the several figures, FIG. 15 is a block diagram exemplifying an implementation of one embodiment 900a of the present technology for delivering user-requested advertisement information from electronic games. The system 900a shown in FIG. 15 includes a user 902 interacting with a client device 904 that includes both computer-readable memory 906 and a processor 908. The memory 906 may be a computer-readable medium, such as random-access-memory (RAM) or a hard-disk drive (HDD). A processor 908 interacts with and executes computer-executable programs that may be stored within the memory 906. Examples of a processor such as 908 include microprocessors, personal computer central processing units (CPUs), or in general any state machines. The processor 908 may be in communication with a device or devices that are wholly comprised of, or otherwise contain, a computer-readable medium (not shown) that can communicate computer-readable instructions to the processor 908. Examples of such computer-readable mediums include external hard-disk drives (HDDs), magnetic disks (‘floppy disks’), and optical disks such as compact disks (CDs) or digital video disks (DVDs).

Client devices 904 may be, but are not limited to, personal computers, mobile phones, cellular phones, smart phones, digital tablets, personal digital assistants, laptop computers, Internet appliances, and other processor-using digital platforms capable of interfacing directly or indirectly with a network such as the Internet, and capable of interacting with application programs. Examples of a client device 904 include a digital tablet executing a browser application program such as Apple Computer, Inc.'s Safari™, or a personal computer executing a browser application program such as Apple Computer, Inc.'s Safari™ and Microsoft Corporation's Internet Explorer™.

Stored on the memory 906 of the client device 904 are two application programs (software) that communicate programmed instructions to the processor 908. These two applications are an electronic game 910 and the client software 912. An electronic game 910 is an application program that runs on a processor-based device (such as the client device 904) that provides entertainment interactivity for the user 902. Examples of electronic games include any and all application programs that are generically referred to as ‘video games.’ The electronic game 910 may be, for example, a personal computer (PC) game that a user 902 runs and interacts with via a personal computer and peripheral hardware, such as a computer keyboard and a computer mouse. Alternatively, the electronic game 910 may be an application stored on a DVD that is executed by a dedicated gaming system and viewed on a monitor or television. The electronic game 910 may also be an application that is stored and executed on a device (not shown) that the client device 904 accesses remotely by way of a network, such as the Internet. Instances of the electronic game 910, and the platform on which its instructions are executed, are not limited by the embodiment of the present technology.

The client software 912 is an application program that allows the user 902 to request and receive advertisement information while interacting with the electronic game 910. The client software 912 may be an application program stored on the memory 906 of the client device, as shown in FIG. 15, or alternatively may be stored and executed by another processor-based device (not shown) that is in communication with the client device 904 via a network, such as the Internet. Additionally, the client software 912 may be an application program that is a subcomponent of another application program (not shown); for example, the client software 912 may be a subcomponent (plugin) of an Internet browser (not shown) being executed by the client device 904.

The client device 904 shown in FIG. 15 is in communication with a server device 916 by way of a network 914. The network 914 may be any system that allows for remote communication of multiple processor-based devices. An example of a network 914, and as shown in FIG. 15, is the Internet. In other embodiments of the present technology, other networks may be used. A server device 916 contains its own computer-readable memory 918 and its own processor 920. Server devices include any device in communication with a single or multiple processor-based devices over a network. The server device 916 as shown in FIG. 15 exists as a single computer device, but in other embodiments may exist as multiple interconnected computer devices or processors, either in communication with each other via physical conduits such as signal cables, or by way of a wireless network. The specific implementation of the server device 916 is not limited by the embodiment of the present technology.

While interacting with the electronic game 910, the user 902 can request information associated with an advertisement displayed within the game. The specific mechanism by which the user 902 requests this information is not limited by the embodiment of the present technology. The information request 928 is sent by the client device 904 through the network 914 to the server device 916. The server device 916, having received the request 928, executes a server program 922 to handle the user's 902 request for advertisement information. Within the request 928 is information that specifically identifies the user 902. This identifying information may be a user identification number or alphanumeric sequence; its specific content and format is not limited by the embodiment of the present technology. The server program 922 uses the information contained within the request 928 to update 930 a user profile database 924 that contains information about the user 902. This information includes, but is not limited to, what advertisement information the user is currently and has previously requested.

The user 902 may presently, or at a later time, retrieve the advertisement information by using the client device 904 to send a retrieval command 932 through the network 914 to the server device 916. After receiving the retrieval command 932, the server device 916 executes the server program 922 to engage in a retrieval process 934 to access and return the advertisement information, which is stored in an advertisement information database (ad database) 926. The specific information to be retrieved is determined by the server program 922 by referencing the user's 902 information that has previously been stored in the user profile database 924. After searching the ad database 926 to retrieve the requested information, the server program 922 executes a process that engages the server device 916 to return 936 the user-requested information through the network 914 back to the client device 904. At this point, the user 902 can access and view the requested information within the electronic game 910, the client software 912, or another application program (not shown) executed by the client device 904.

In other embodiments, the client software 912 may be executed by a different client device (not shown), so long as that client device is able to communicate with the client device 904 on which the electronic game 910 is executed. For example, the client device 904 executing the electronic game may, using a Bluetooth™ connection, pass the user's 902 request for ad info 928 to the user's 902 mobile phone (not shown), which executes the client software 912 to communicate over the network 914 with the server 916 and handle the request for advertising information. Thus, the user 902 may request and receive the advertising information from within the electronic game 910 regardless of whether the client device 904 may communicate through the network 914, so long as the client device 904 is able to communicate with a different client device (not shown) that can execute the client software 912 and communicate over the network 914. The methods of communication between these client devices are not limited by the embodiment of the present technology.

The advantages of the technology for delivering user-requested advertisement information include, without limitation, a novel collection of systems and methods that allow a user of an electronic game to request and receive information regarding an advertisement displayed within the electronic game. These systems and methods allow for the user to request and receive this information without interrupting any interactivity with the electronic game.

In broad embodiment, the present technology is a collection of systems and methods that both facilitates a user's ability to quickly request information about products or services advertised within an electronic game, and also facilitates an advertiser's ability to place advertisements within electronic games without interrupting a user's interaction with that game.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In one or more exemplary designs, the functions described herein may be encoded as instructions in hardware, software, firmware, or any combination thereof, for execution by a processor. If encoded in software, the functions may be stored on or transmitted over as one or more instructions or code on a non-transitory computer-readable medium. Computer-readable media may include both computer storage media and non-transitory communication media including any medium that facilitates transfer of a computer program from one place to another. A storage media may be any available media that can be accessed by a general purpose or special purpose computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

The previous description of the disclosed embodiments is provided to enable any person skilled in the art to make or use the embodiments disclosed. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for cross-platform collection and distribution of advertising information, comprising:
maintaining, in a computer memory, a data structure relating unique advertisement identifiers associated with respective corresponding advertisements distributed across multiple media platforms;
receiving, by a computer server, defined electronic signals comprising ones of the unique advertising identifiers associated with respective user identifiers;
maintaining, in a computer memory, records of the ones of the advertising identifiers associated with each of the user identifiers received in the defined electronic signals;
selecting destination clients based on the user identifiers; and
transmitting supplemental content selected based on the advertising identifiers to the destination clients.

2. The method of claim 1, further comprising assigning the unique advertisement identifiers to one or more advertisements for distribution across multiple media platforms, in response to registration requests from advertisers.

3. The method of claim 1, further comprising collecting the supplemental content from one or more sources.

4. The method of claim 3, further comprising allocating the supplemental content to respective ones of the advertising identifiers in a computer data structure.

5. The method of claim 3, wherein the one or more sources include advertisers publishing the advertisements.

6. The method of claim 5, further comprising including promotional material from the advertisers in the supplemental content.

7. The method of claim 1, further comprising including consumer reviews collected from other users in the supplemental information.

8. The method of claim 1, further comprising receiving a request for the supplemental information from a client device, wherein the request includes one of the user identifiers.

9. The method of claim 8, further comprising formatting the supplemental information for display for a platform type compatible with the client device, prior to the transmitting.

10. The method of claim 8, further comprising including an interface object in the supplemental information for input of user data on the client device and providing the input as user feedback.

11. A computer system comprising at least one processor and a memory coupled to the at least one processor; wherein the memory holds program instructions, that when executed by the at least one processor, causes the computer system to perform:
maintaining, in the memory, a data structure relating unique advertisement identifiers associated with respective corresponding advertisements distributed across multiple media platforms;
receiving electronic signals comprising ones of the unique advertising identifiers associated with respective user identifiers;
maintaining, in the memory, records of the ones of the advertising identifiers associated with each of the user identifiers received in the defined electronic signals;
selecting destination clients based on the user identifiers; and
transmitting supplemental content selected based on the advertising identifiers to the destination clients

12. The apparatus of claim 11, wherein the program instructions are further configured for assigning the unique advertisement identifiers to one or more advertisements for distribution across multiple media platforms, in response to registration requests from advertisers.

13. The apparatus of claim 11, wherein the program instructions are further configured for collecting the supplemental content from one or more sources.

14. The apparatus of claim 13, wherein the program instructions are further configured for allocating the supplemental content to respective ones of the advertising identifiers in a computer data structure.

15. The apparatus of claim 13, wherein the program instructions are further configured for identifying the one or more sources with advertisers publishing the advertisements.

16. The apparatus of claim 15, wherein the program instructions are further configured for including promotional material from the advertisers in the supplemental content.

17. The apparatus of claim 11, wherein the program instructions are further configured for including consumer reviews collected from other users in the supplemental information.

18. The apparatus of claim 11, wherein the program instructions are further configured for receiving a request for the supplemental information from a client device, wherein the request includes one of the user identifiers.

19. The apparatus of claim 18, wherein the program instructions are further configured for formatting the supplemental information for display for a platform type compatible with the client device, prior to the transmitting.

20. The apparatus of claim 18, wherein the program instructions are further configured for including an interface object in the supplemental information for input of user data on the client device and providing the input as user feedback.
